(19) United States
(12) Patent Application Publication
(10) Pub. No.: US 2004/0122741 A1
(43) Pub. Date: Jun. 24, 2004

(54) Apparatus, method and system for effecting information access in a peer environment

(76) Inventor: David Sidman, Brooklyn, NY (US)

Correspondence Address: Walter G Hanchuk, Morgan & Finnegan, 345 Park Avenue, New York, NY, 10154, US

(21) Appl. No.: 10/470,206

(22) PCT Filed: Jan. 25, 2002
(86) PCT No.: PCT/US02/02475

(51) Int. Cl. G06F 17/60

(52) U.S. Cl. 705/26

(57) ABSTRACT

An apparatus, method and system to catalog, mark, facilitate searches, transfer, and validate information across a peer-to-peer (P2P) network. The present disclosure teaches how to discern and associate content referenced by a DOI with substantively similar copies of said content. Content that does not contain a DOI reference may be marked with its discerned and associated DOI to facilitate P2P transactions. By discerning that copies of said content across a P2P network are related to a publisher's DOI referenced content, the availability and/or quality of content in a distributed network is improved. This improvement may be achieved by verifying that content obtained from search queries on a P2P network is the same as a publisher's DOI referenced content. This results in content that is discerned and/or more easily discernable; i.e., it is easier to discern that any copies of originating content are of sufficient fidelity to be substantively related as compared to the originating content. The present disclosure further teaches that digital rights management may be enhanced by such discerned content by encouraging the propagation of content with embedded digital rights management materials when so desired by the publisher. As a result, the disclosure enables the distribution and propagation of a more uniform collection of content across a communications network. Furthermore, the disclosure enables standard DOI systems to operate in a P2P environment where multiple peers not controlled by content owners may affect the availability and access of content in either or both the handle system and P2P network.

### RELATED APPLICATIONS

The instant application hereby claims priority to the following U.S. provisional patent applications: (1) serial No. 60/264,333 for “Reference Linking with DOIs” filed on Jan. 25, 2001 (attorney docket number 4188-4001); (2) serial No. 60/268,766 for “Apparatus, Method, and System for Multiple Resolution Affecting Information Access” filed on Feb. 14, 2001 (attorney docket number 4188-4002); (3) serial No. 60/276,459 for “Apparatus, Method, and System for Registration Effecting Information Access” filed on Mar. 16, 2001 (attorney docket number 4188-4003); (4) serial No. 60/279,792 for “Apparatus, Method and System For Directory Quality Assurance” filed on Mar. 29, 2001 (attorney docket number 4188-4004); (5) serial No. 60/303,768 for “Apparatus, Method, and System for Accessing Digital Rights Management Information” filed on Jul. 10, 2001 (attorney docket number 4188-4005); (6) serial No. 60/328,275 for “Apparatus, Method and System For Accessing Digital Rights Management Information” filed on Oct. 9, 2001 (attorney docket number 4188-4005US1); (7) serial No. 60/267,875 for “Apparatus, Method, and System for Accessing Information” filed on Feb. 8, 2001 (attorney docket number 4188-4006); (8) serial No. 60/267,899 for “Provisional filing for Apparatus, Method, and System for Accessing Information” filed on Feb. 9, 2001 (attorney docket number 4188-4007); (9) serial No. 60/270,473 for “Business Value and Implementation Considerations For The DOI” filed on Feb. 21, 2001 (attorney docket number 4188-4008); (10) serial No. 60/328,274 for “Apparatus, Method And System For Effecting Information Access In A Peer Environment” filed on Oct. 9, 2001 (attorney docket number 4188-4010); (11) serial No. 60/328,270 for “Apparatus, Method and System For Tracking Information Access” filed on Oct. 9, 2001 (attorney docket number 4188-4011); each of these applications being herein incorporated by reference.

The instant application, also, hereby incorporates by reference the following Patent Cooperation Treaty applications: (12) for an “Apparatus, Method and System For Multiple Resolution Affecting Information Access” (attorney docket number 4188-4002PC), which was filed on Jan. 25, 2002 in the name of David Sidman; (13) for an “Apparatus, Method and System For Registration Effecting Information Access” (attorney docket number 4188-4003PC), which was filed on Jan. 25, 2002 in the name of David Sidman; (14) for an “Apparatus, Method and System For Directory Quality Assurance” (attorney docket number 4188-4004PC), which was filed on Jan. 25, 2002 in the name of David Sidman; (15) Apparatus, Method and System For Accessing Digital Rights Management Information” (attorney docket number 4188-4005PC1), which was filed on Jan. 25, 2002 in the name of David Sidman; and (16) for an “Apparatus, Method and System For Tracking Information Access,” (attorney docket number 4188-4011PC), which was filed on Jan. 25, 2002 in the name of David Sidman.

### FIELD

The present invention relates generally to an apparatus, method and system to access information across peer-to-peer communications network. More particularly, the disclosed invention relates to an apparatus, method and system to facilitate the distribution, propagation, and transfer of more uniform copies of content based on the publisher's approved content.

### BACKGROUND

Internet

As Internet usage increases, the amount of information available on the Internet also increases. The information that exists on the Internet is of many different types, including documents in many formats such as: computer software, databases, discussion lists, electronic journals, library catalogues, online information services, mailing lists, news groups, streaming media, and the like. Fortunately, much of the information on the Internet can be accessed through the World-Wide Web using a web browser to interact with the network in a user-friendly way.

Networks

Networks are commonly thought to consist of the interconnection and interoperation of clients, peers, servers, and intermediary nodes in a graph topology. It should be noted that the term “server” as used herein refers generally to a computer, other device, software, or combination thereof that processes and responds to the requests of remote users across a communications network. Servers serve their information to requesting “clients.” A computer, other device, software, or combination thereof that facilitates, processes information and requests, and/or furthers the passage of information from a source user to a destination user is commonly referred to as a “node.” Networks are generally thought to facilitate the transfer of information from source points to destinations.

Transmission Control Protocol-Internet Protocol (TCP/IP)

The proliferation and expansion of computer systems, databases, and networks of computers has been facilitated by an interconnection of such systems and networks in an extraterritorial communications network commonly referred to as the Internet. The Internet has developed and largely employs the Transmission Control Protocol-Internet Protocol (TCP/IP). TCP/IP was developed by a Department of Defense (DoD) research project to interconnect networks made by various and varying network vendors as a foundation for a network of networks, i.e., the Internet. The development of TCP/IP was in part driven by a requirement by the DoD to have a network that will continue to operate even if damaged during battle, thus allowing for information to be routed around damaged portions of the communications network to destination addresses. Of course, if the source or destination address location itself is rendered inoperable, such delivery will not be possible.

The Internet is a packet-switched network and thus, information on the Internet is broken up into pieces, called packets, and transmitted in packet form. The packets contain IP addressing information called headers, which are used by routers to facilitate the delivery of the packets from a source to a destination across intermediary nodes on the Internet. Upon arrival at the destination, the packets are reassembled to form the original message, and any missing packets are requested again.

The IP component of the protocol is responsible for routing packets of information based on a four byte addressing mechanism; the address is written as four numbers separated by dots, each number ranging from 0 to 255, e.g., “123.255.0.123”. IP addresses are assigned by Internet authorities and registration agencies, and are unique.

The TCP portion of the protocol is used for verifying that packets of information are correctly received by the destination computer from the source, and if not, to retransmit corrupt packets. Other transmission control protocols are also commonly used that do not guarantee delivery, such as User Datagram Protocol (UDP).

World Wide Web

The proliferation and expansion of the Internet, and particularly the World Wide Web (the web), have resulted in a vast and diverse collection of information. Various user interfaces that facilitate the interaction of users with information technology systems (i.e., people using computers) are currently in use. An information navigation interface called WorldWideWeb.app (the web) was developed in late 1990. Subsequently, information navigation interfaces such as web browsers have become widely available on almost every computer operating system platform.

Generally, the web is the manifestation and result of a synergetic interoperation between user interfaces (e.g., web browsers), servers, distributed information, protocols, and specifications. Web browsers were designed to facilitate navigation and access to information, while information servers were designed to facilitate provision of information. Typically, web browsers and information servers are disposed in communication with one another through a communications network. Information Servers function to serve information to users that typically access the information by way of web browsers. As such, information servers typically provide information to users employing web browsers for navigating and accessing information on the web. Microsoft's Internet Explorer and Netscape Navigator are examples of web browsers. In addition, navigation user interface devices such as WebTV have also been implemented to facilitate web navigation. Microsoft's Information Server and Apache are examples of information servers.

Universal Resource Locator (URL)

The expansion of the web has resulted in an enormous quantity of information, which is accessible through the use of Universal Resource Locators (URLs). An URL is an address that is typically embodied as a hyperlink in a web page or is typed into a web browser. URLs for a given resource (most commonly a file located on a remote computer) refer only to a location for that resource. Typically, the reference to the location is achieved through the use of an unresolved IP address in conjunction with a directory path and file name; e.g., “http://www.aWebSite.com/aFolder/aFile.html”. In this example, the URL directs the browser to connect to the computer named “www” in the domain “aWebSite.com,” and to request the file named “aFile.html” stored in directory “aFolder” at that computer.

Universal Name Identifier (UNI)

The Corporation for National Research Initiatives has created and implemented a new means of naming and locating information, called the Handle System. The Handle System is designed to improve upon the current use of URLs.

The Handle System introduces a level of indirection to locating and distributing information over the Internet. The Handle System is a general-purpose system for naming resources. Instead of being assigned a URL based on a particular resource's current network location, a resource may be assigned a Universal Name Identifier. A UNI is a form of Universal Resource Identifier (URI). URIs include both UNIs and URLs. A UNI, unlike a URL, serves and shall be regarded henceforth as a name for the resource that is persistent regardless of changes in the resource's location or other attributes. In turn, a Universal Resource Name (URN) is a type of UNI (i.e., a UNI subsumes the concept of a URN). Furthermore, a Handle is a type of URN. And a Digital Object Identifier (DOI) is a type of Handle. Thus, various forms of UNIs include Handles, URNs, DOIs, and/or the like. The various terms and/or forms of UNIs will be used interchangeably throughout this document, and may be assumed to be interchangeable unless stated otherwise. A Handle is a unique name, which is registered with the Handle System along with the current network location of the named resource. This location information commonly takes the form of a URL. One common type of Handle is known as a Digital Object Identifier (DOI). Handles may be then distributed to users in lieu of a URL, and superficially appear to function similarly to a hyperlink. When a user encounters a Handle, the user may select or enter the Handle much like a URL hyperlink, so long as the user's web browser is capable of making Handle requests. Such an encounter triggers an automated process to look up a resource's current location. The current location of the resource is associated with the resource's Handle in a directory made available by the Handle System, which in turn directs the user to the resource's current location. Unlike with a URL, if the resource moves, the Handle System directory entry can be updated, thereby assuring a persistent association between a Handle and the resource it identifies. An analogy can be made to the physical world: knowing only a URL for a given resource is akin to knowing only a person's street address, and not her name. If she were to move across town, it would be very difficult to locate her without knowing her name. The Handle System allows resources to be permanently named by way of a Handle, and it allows the current network location of resources to be looked up based on that name in a Handle System directory.

Digital Rights Management (DRM)

Digital Rights Management (DRM) involves the description, layering, analysis, valuation, trading, and monitoring of an owner's property rights to an asset. DRM covers the management of the digital rights to the physical manifestation of a work (e.g., a textbook) or the digital manifestation of a work (e.g., a web page). DRM also covers the management of an asset whether the asset has a tangible or an intangible value. Current DRM systems include languages for describing the terms and conditions for use of an asset, tracking asset usage by enforcing controlled environments or encoded asset manifestations, and closed architectures for the overall management of the digital rights. Current DRM systems rely upon location-based identifiers such as the URL.

Peer-To-Peer Communications (P2P)

People use peer-to-peer (P2P) applications to facilitate the distribution of information and computing resources. A basic P2P solution provides each user on a network with both a server and client application that allows each user to respectively make available and access resources (e.g., files, CPU time, memory, etc.) with other users. As such each combined client and server node on a P2P network is referred to as a peer. Examples such as Gnuetella, MusicCity (e.g, Morpheus), and Napster networks evince the public's desire to share files in a distributed and unfettered fashion.

### SUMMARY

Digital Object Identifiers overcome many of the shortcomings of IP- and other location-based addressing schemes. DOIs enable access to information over a communications network by providing a persistent identifier for information that may be regularly relocated. DOIs overcome the limitations of network addressing schemes limited to addressing locations by providing a mechanism to associate identifiers with information through an added level of indirection instead of associating identifiers with locations.

Although DOIs provide a mechanism that allows for the association of an identifier with information instead of a location, DOIs in and of themselves do not provide for the access of multiple and/or varying instances of a piece of information in various locations, formats, or the access of various services associated with a given piece of information, based on various contexts of use.

In one embodiment of the present invention, a method is taught for using a peer to catalog information. The method: mining source identifying data as metadata from within new information and querying a database holding unique, persistent, and universal name identifiers (UPUNI) and metadata (MUPUNI database; i.e., a database that stores both metadata and UPUNIs) with the mined metadata for an UPUNI corresponding to the mined metadata, if the new information has no embedded UPUNI; resolving an UPUNI to location addresses for accessing originating versions of the information; and adding an entry of the new information's availability into a local data-structure to catalog information items available on a peer for transmission to others.

In another embodiment of the present invention, a method is taught for using a peer to access information. The method comprises: searching for peers with an obtained unique, persistent, and universal name identifier (UPUNI) for desired information, which corresponds to the obtained UPUNI; obtaining search results; identifying candidate peers from which to obtain desired information that corresponds to the obtained UPUNI; requesting desired information from a candidate peer; and obtaining the desired information from the candidate peer.

In another embodiment of the present invention, a method is taught for using a peer to validate information. The method comprises: obtaining an unique, persistent, and universal name identifier (UPUNI) for identified information; requesting validating credentials for the identified information from an UPUNI resolution system with the obtained UPUNI; obtaining the requested validating credentials; and comparing a representative digital verification value against the obtained validating credentials.

In another embodiment of the present invention, a memory storing a data structure is taught. The data structure has associated data types, including: a data type to store a unique, persistent, and universal name identifier (UPUNI); and a data type to store location addresses of peers with information substantively similar to information referenced by the UPUNI.

The above advantages and features are of representative embodiments only, and are not exhaustive and/or exclusive. They are presented only to assist in understanding the invention. It should be understood that they are not representative of all the inventions defined by the claims, to be considered limitations on the invention as defined by the claims, or limitations on equivalents to the claims. For instance, some of these advantages may be mutually contradictory, in that they cannot be simultaneously present in a single embodiment. Similarly, some advantages are applicable to one aspect of the invention, and inapplicable to others. Furthermore, certain aspects of the claimed invention have not been discussed herein. However, no inference should be drawn regarding those discussed herein relative to those not discussed herein other than for purposes of space and reducing repetition. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

The accompanying drawings illustrate certain embodiments of the disclosure.

FIG. 1 illustrates one example embodiment incorporated into a DOI Enabled Peer-to-Peer (DE2P) controller;

FIGS. 2 and 3 illustrate URL addressing across a communications network with moving information;

FIG. 4 illustrates accessing of information through DOIs;

FIGS. 5 and 6 provide an overview of a Handle;

FIGS. 7 and 8 provide an overview of the resolution mechanism for allowing users to access desired information;

FIG. 9 provides an overview of an exemplary sequence of actions that a user performs to access information using DOIs;

FIG. 10 provides a more complete overview of an exemplary sequence of actions that users perform to access content information;

FIG. 11 illustrates an exemplary mechanism for accessing information over a communications network;

FIG. 12 provides an overview of another embodiment of exemplary mechanisms for retrieving information over a communications network;

FIG. 13 provides an overview of an exemplary DOI system;

FIG. 14 depicts one non-limiting example embodiment of data flow for a cataloguing system effecting information access in a peer-to-peer environment;

FIG. 15 shows the logic flow of one non-limiting example embodiment of a cataloguing system for effecting information access in a peer-to-peer environment;

FIG. 16 depicts a data flow diagram of a file search and request system effecting information access in a P2P environment;

FIG. 17 is a logic flow diagram for a file search and request system for effecting information access in a P2P environment;

FIG. 18 illustrates a data flow diagram for a post-receipt validation system for effecting information access in a P2P environment;

FIG. 19 depicts a logic flow diagram for a file receipt validation system for effecting information access in a P2P environment.

### DETAILED DESCRIPTION

DOI Enabled Peer-To-Peer Controller

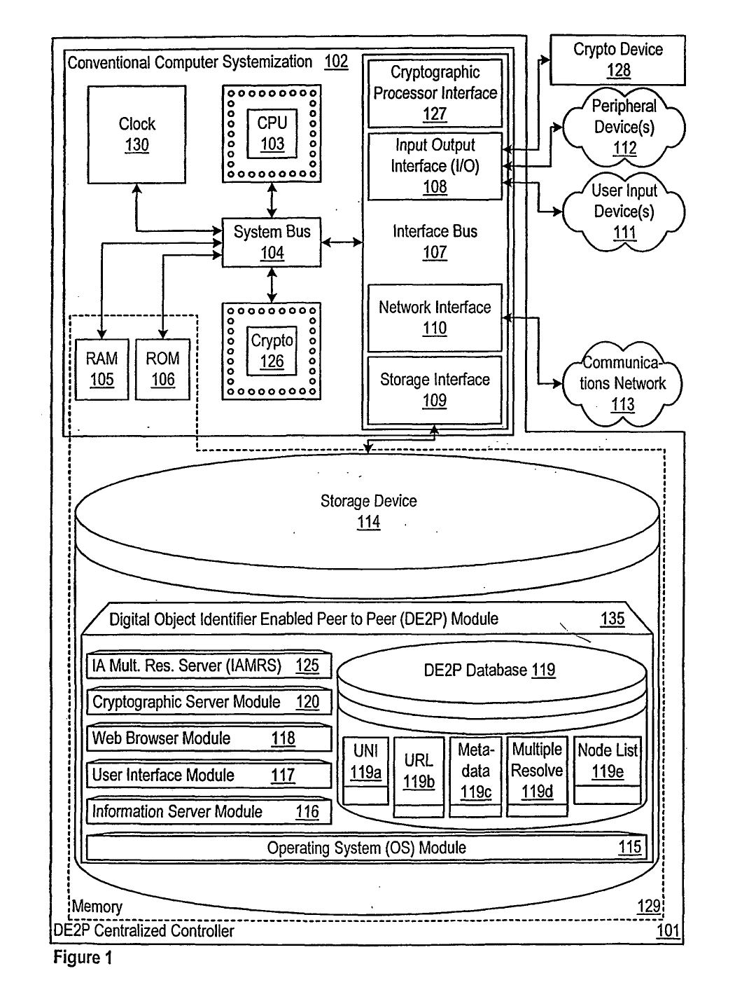

FIG. 1 illustrates one non-limiting example embodiment incorporated into a Digital Object Identifier Enabled Peer-to-peer (DE2P) controller 101. In this embodiment, the DE2P controller 101 may serve to register, resolve, process, store, update, and validate Handles and any associated information, and/or the like.

In one embodiment, the DE2P controller 101 may be connected to and/or communicate with entities such as, but not limited to: one or more users from user input devices 111; peripheral devices 112; and/or a communications network 113. The DE2P controller may even be connected to and/or communicate with a cryptographic processor device 128.

A typical DE2P controller 101 may be based on common computer systems that may comprise, but are not limited to, components such as: a computer systemization 102 connected to memory 129.

Computer Systemization

A computer systemization 102 may comprise a clock 130, central processing unit (CPU) 103, a read only memory (ROM), a random access memory (RAM), and/or an interface bus 107, and conventionally, although not necessarily, are all interconnected and/or communicating through a system bus 104. The system clock typically has a crystal oscillator and provides a base signal. The clock is typically coupled to the system bus and various means that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Optionally, a cryptographic processor 126 may similarly be connected to the system bus. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as the Intel Pentium Processor and/or the like. The CPU interacts with memory through signal passing through conductive conduits to execute stored program code according to conventional data processing techniques. Such signal passing facilitates communication within the DE2P controller and beyond through various interfaces.

Interface Adapters

Interface bus(ses) 107 may accept, connect, and/or communicate to a number of interface adapters, conventionally although not necessarily in the form of adapter cards, such as but not limited to: input output interfaces (I/O) 108, storage interfaces 109, network interfaces 10, and/or the like. Optionally, cryptographic processor interfaces 127 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (PCI), Personal Computer Memory Card International Association (PCMCIA), and/or the like.

Storage interfaces 109 may accept, communicate, and/or connect to a number of storage devices such as, but not limited to: storage devices 114, removable disc devices, and/or the like. Storage interfaces may employ connection protocols such as, but not limited to: (Ultra) Advanced Technology Attachment (Packet Interface) ((Ultra) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 110 may accept, communicate, and/or connect to a communications network 113. Network interfaces may employ connection protocols such as, but not limited to: direct connect, Ethernet (thick, thin, twisted pair 10/100/1000 Base T, and/or the like), Token Ring, wireless connection such as IEEE 802.11b, and/or the like. A communications network may be any one and/or the combination of the following: a direct interconnection; the Internet; a Local Area Network (LAN); Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface.

Input Output interfaces (I/O) 108 may accept, communicate, and/or connect to user input devices 111, peripheral devices 112, cryptographic processor devices 128, and/or the like. 1/0 may employ connection protocols such as, but not limited to: Apple Desktop Bus (ADB); Apple Desktop Connector (ADC); audio: analog, digital, monaural, RCA, stereo, and/or the like; IEEE 1394; infrared; joystick; keyboard; midi; optical; PC AT; PS/2; parallel; radio; serial; USB; video interface: BNC, composite, digital, RCA, S-Video, VGA, and/or the like; wireless; and/or the like. A common output device is a video display, which typically comprises a CRT or LCD based monitor with an interface (e.g., VGA circuitry and cable) that accepts signals from a video interface. The video interface composites information generated by a computer systemization and generates video signals based on the composited information. Typically, the video interface provides the composited video information through a video connection interface that accepts a video display interface (e.g., a VGA connector accepting a VGA display cable).

User input devices 111 may be card readers, dongles, finger print readers, gloves, graphics pads, joysticks, keyboards, mouse (mice), trackballs, trackpads, retina readers, and/or the like.

Peripheral devices 112 may be connected and/or communicate with or to I/O and/or with or to other facilities of the like such as network interfaces, storage interfaces, and/or the like). Peripheral devices may be cameras, dongles (for copy protection, ensuring secure transactions as a digital signature, and/or the like), external processors (for added functionality), goggles, microphones, monitors, network interfaces, printers, scanners, storage devices, visors, and/or the like.

Cryptographic units such as, but not limited to, microcontrollers, processors 126, interfaces 127, and/or devices 128 may be attached, and/or communicate with the DE2P controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 284.

Memory

A storage device 114 may be any conventional computer system storage. Storage devices may be a fixed hard disk drive, and/or other devices of the like. However, it is to be understood that a DE2P controller and/or a computer systemization may employ various forms of memory 129. For example, a computer systemization may be configured wherein the functionality of on-chip CPU memory (e.g., registers), RAM, ROM, and any other storage devices are provided by a paper punch tape or paper punch card mechanism; of course such an embodiment is not preferred and would result in an extremely slow rate of operation. In a typical configuration, memory 129 will include ROM, RAM, and a storage device 114. Generally, any mechanization and/or embodiment allowing a processor to affect the storage and/or retrieval of information is regarded as memory 129. Thus, a computer systemization generally requires and makes use of memory. However, memory is a fungible technology and resource, thus, any number of memory embodiments may be employed in lieu of or in concert with one another.

Module Collection

The storage devices 114 may contain a collection of program and/or database modules and/or data such as, but not limited to: an operating system module 115 (operating system); an information server module 116 (information server); a user interface module 117 (user interface); a web browser module 118 (web browser); databases 119; a cryptographic server module 120 (cryptographic server); DOI Enabled Peer-to-Peer (DE2P) module 125; and/or the like (i.e., collectively a module collection). These modules may be stored and accessed from the storage devices and/or from storage devices accessible through an interface bus. Although non-conventional software modules such as those in the module collection, typically and preferably, are stored in a local storage device 114, they may also be loaded and/or stored in memory such as: peripheral devices, RAM, remote storage facilities through a communications network, ROM, various forms of memory, and/or the like.

Operating System

The operating system module 115 is executable program code facilitating the operation of a DE2P controller. Typically, the operating system facilitates access of I/O, network interfaces, peripheral devices, storage devices, and/or the like. The operating system preferably is a conventional product such as Apple Macintosh OS X Server, AT&T Plan 9, Microsoft Windows NT Server, Unix, and/or the like operating systems. Preferably, the operating system is highly fault tolerant, scalable, and secure. An operating system may communicate to and/or with other modules in a module collection, including itself, and/or facilities of the like. Conventionally, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. Preferably, the operating system provides communications protocols that allow the DE2P controller to communicate with other entities through a communications network 113. Various communication protocols may be used by the DE2P controller as a subcarrier transport mechanism for interacting with the Handle System, such as, but not limited to: multicast, TCP/IP, UDP, unicast, and/or the like.

Information Server

An information server module 116 is stored program code that is executed by the CPU. The information server may be a conventional Internet information server such as, but not limited to, Microsoft's Internet Information Server and/or the Apache Software Foundation's Apache. Preferably, the information server allows for the execution of program modules through facilities such as C++, Java, JavaScript, ActiveX, Common Gateway Interface (CGI) scripts, Active Server Page (ASP), and/or the like. Preferably the information server supports secure communications protocols such as, but not limited to, File Transfer Protocol (FTP); HyperText Transfer Protocol (HTTP), Secure Hypertext Transfer Protocol (HTTPS), Secure Socket Layer (SSL), and/or the like. Conventionally, an information server provides results in the form of web pages to web browsers, and allows for the manipulated generation of the web pages through interaction with other program modules. After a DNS resolution portion of an HTTP request is resolved to a particular information server, the information server resolves requests for information at specified locations on a DE2P controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” An information server may communicate to and/or with other modules in a module collection, including itself, and/or facilities of the like. Most frequently, the information server communicates with operating systems, other program modules, user interfaces, web browsers, and/or the like. An information server may contain, communicate, generate, obtain, and/or provide program module, system, user, and/or data communications, requests, and/or responses.

User Interface

A user interface module 117 is stored program code that is executed by the CPU. Preferably, the user interface is a conventional graphic user interface as provided by, with, and/or atop operating systems and/or operating environments such as Apple Macintosh OS, e.g., Aqua, Microsoft Windows (NT), Unix X Windows (KDE, Gnome, and/or the like), and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A web browser module 118 is stored program code that is executed by the CPU. Preferably, the web browser is a conventional hypertext viewing application such as Microsoft Internet Explorer or Netscape Navigator (preferably with 128 bit encryption by way of HTTPS, SSL, and/or the like). Some web browsers allow for the execution of program modules through facilities such as Java, JavaScript, ActiveX, and/or the like. In one embodiment, web browsers are handle-enabled by way of a browser plug-in software such as the Handle System plug-in available from www.cnri.org. In an alternative embodiment handle support is integrated into the web browser. Web browsers and like information access tools may be integrated into PDAs, cellular telephones, and/or other mobile devices. A web browser may communicate to and/or with other modules in a module collection, including itself, and/or facilities of the like. Most frequently, the web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a web browser and information server, a combined application may be developed to perform similar functions of both. The combined application would similarly affect the obtaining and the provision of information to users, user agents, and/or the like from DE2P enabled nodes. The combined application may be nugatory on systems employing standard web browsers. Such a combined module could be configured to communicate directly with the DE2P without an intermediary information server to further enhance security.

DE2P Database

A DE2P database module 119 may be embodied in a database that is stored program code that is executed by the CPU and its stored data; the stored program code portion configuring the CPU to process the stored data. Preferably, the database is a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the DE2P database may be implemented using various standard data-structures, such as an array, hash, (linked) list, struct, table, and/or the like. Such data-structures may be stored in memory and/or in (structured) files. If the DE2P database is implemented as a data-structure, the use of the DE2P database may be integrated into another module such as the DE2P module. Databases may be consolidated and/or distributed in countless variations through standard data processing techniques. Portions of databases, e.g., tables, may be exported and/or imported and thus decentralized and/or integrated. In one non-limiting example embodiment, the database module 119 includes tables such as but not limited to a UNI (e.g., Handle, DOI and/or other UNIs) table 119a, URL table 119b, metadata table 119c, multiple resolution table 119d, a node list table 119e, and/or the like. All the tables may be related by (enhanced) DOI key field entries as they are unique. In an alternative embodiment, these tables have been decentralized into their own databases and their respective database controllers (i.e., individual database controllers for each of the above tables). Of course, employing standard data processing techniques, one may further distribute the databases over several computer systemizations and/or storage devices. Similarly, configurations of the decentralized database controllers may be varied by consolidating and/or distributing the various database modules 119a-e. The DE2P may be configured to keep track of user requests and various transactions tracking via database controllers.

A DE2P database may communicate to and/or with other modules in a module collection, including itself, and/or facilities of the like. Most frequently, the DE2P database communicates with a DE2P module, other program modules, and/or the like. The database may contain, retain, and provide information regarding other nodes and data.

Cryotographic Server

A cryptographic server module 120 is stored program code that is executed by the CPU 103, cryptographic processor 126, cryptographic processor interface 127, cryptographic processor device 128, and/or the like. Preferably, cryptographic processor interfaces will allow for expedition of encryption and/or decryption requests by the cryptographic module; however, the cryptographic module, alternatively, may run on a conventional CPU. Preferably, the cryptographic module allows for the encryption and/or decryption of provided data. Preferably, the cryptographic module allows for both symmetric and asymmetric (e.g., Pretty Good Protection (PGP)) encryption and/or decryption. Preferably, the cryptographic module allows conventional cryptographic techniques such as, but not limited to: digital certificates (e.g., X.509 authentication framework), digital signatures, dual signatures, enveloping, password access protection, public key management, and/or the like. Preferably, the cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, RC5 (Rivest Cipher), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. The cryptographic module facilitates the process of“security authorization” whereby access to a resource is inhibited by a security protocol wherein the cryptographic module effects authorized access to the secured resource. A cryptographic module may communicate to and/or with other modules in a module collection, including itself, and/or facilities of the like. Preferably, the cryptographic module supports encryption schemes allowing for the secure transmission of information across a communications network to enable a DE2P module to engage in secure transactions if so desired by users. The cryptographic module facilitates the secure accessing of resources on DE2P and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

Information Access Multiple Resolution Server (IAMRS)

An IAMRS module 125 is stored program code that is executed by the CPU. Generally, the DE2P affects accessing, obtaining and the provision of information, and/or the like between nodes on a communications network. The IAMRS has the ability to resolve UNIs to multiple instantiations. Generally, the IMRS acts as a lookup facility to create, maintain, and update associations between a given piece of information, its DOI, and its current locations. The IAMRS coordinates with the DE2P database to identify nodes that may be useful for improving data transfer for requested information, for resolving to various formats of the requesting information, providing an enhanced mechanism to create queries regarding the information, and/or the like. An IAMRS enabling access of information between nodes may be developed by employing standard development tools such as, but not limited to: C++, shell scripts, Java, Javascript, SQL commands, web application server extensions, Apache modules, Perl scripts, binary executables, and/or other mapping tools, and/or the like. In one non-limiting example embodiment, the IAMRS server employs a cryptographic server to encrypt and decrypt communications. The IAMRS may service requests, update association information for UNIs, and much more. A DE2P module may communicate to and/or with other modules in a module collection, including itself, and/or facilities of the like. Most frequently, the IAMRS module communicates with a DE2P database, operating systems, other program modules, and/or the like. The IAMRS may contain, communicate, generate, obtain, and/or provide program module, system, user, and/or data communications, requests, and/or responses.

DOI Enabled Peer

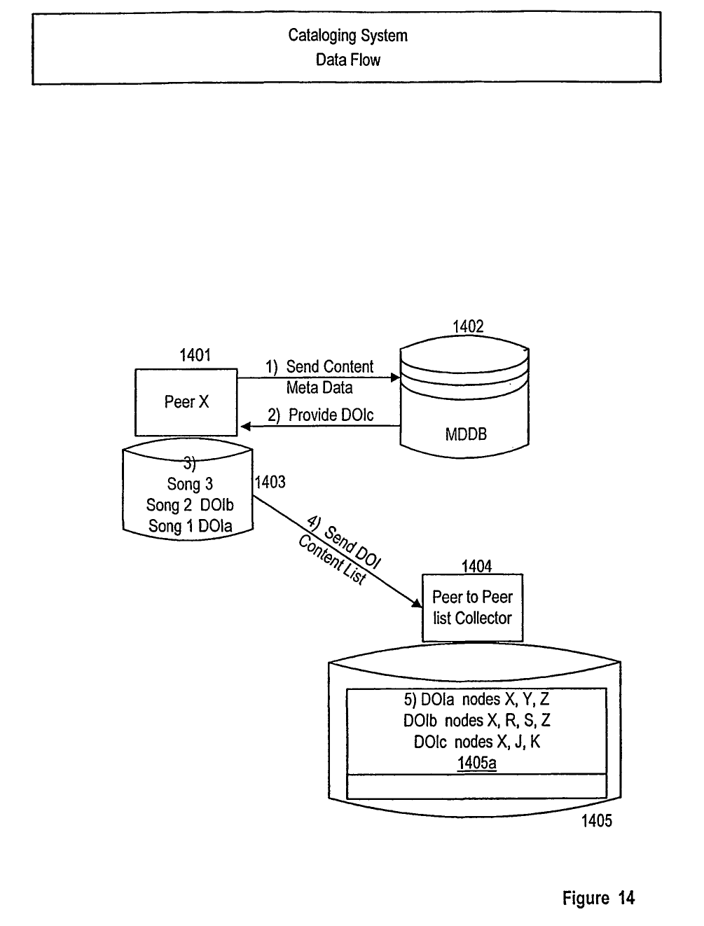

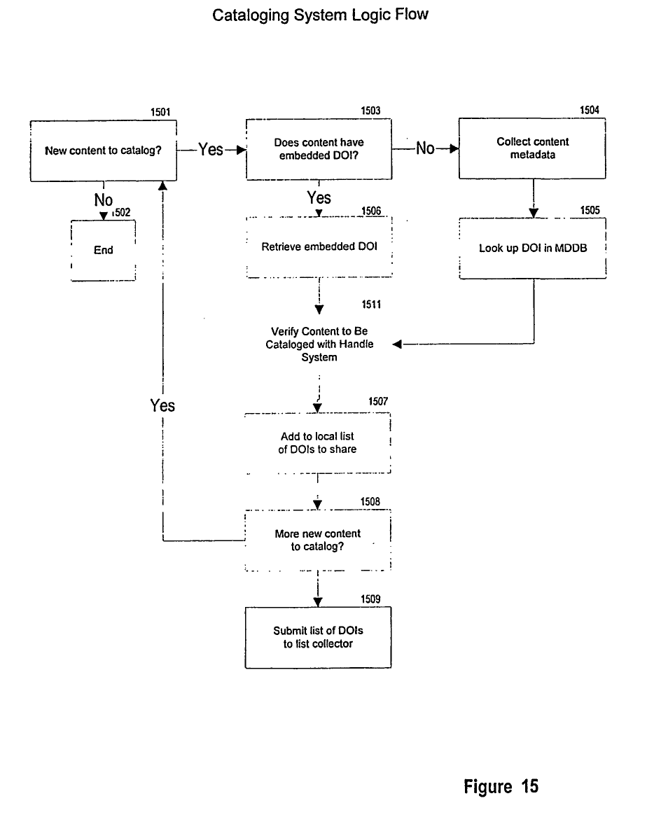

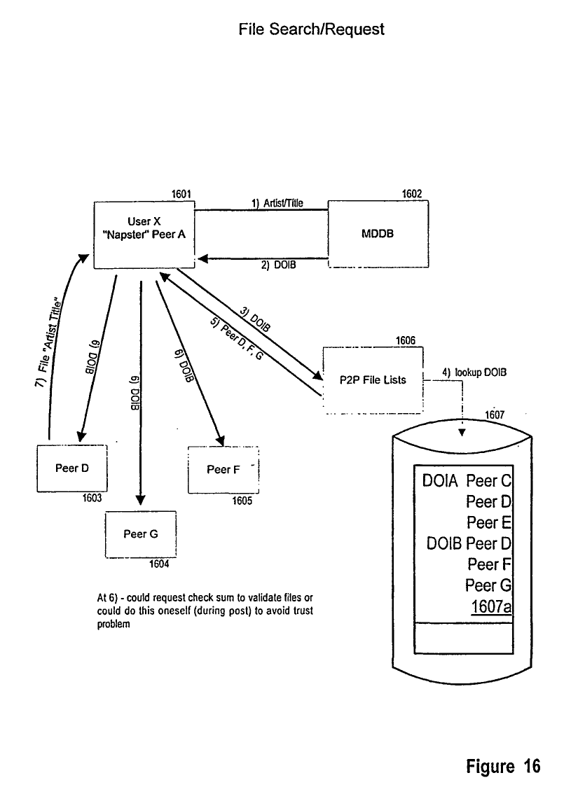

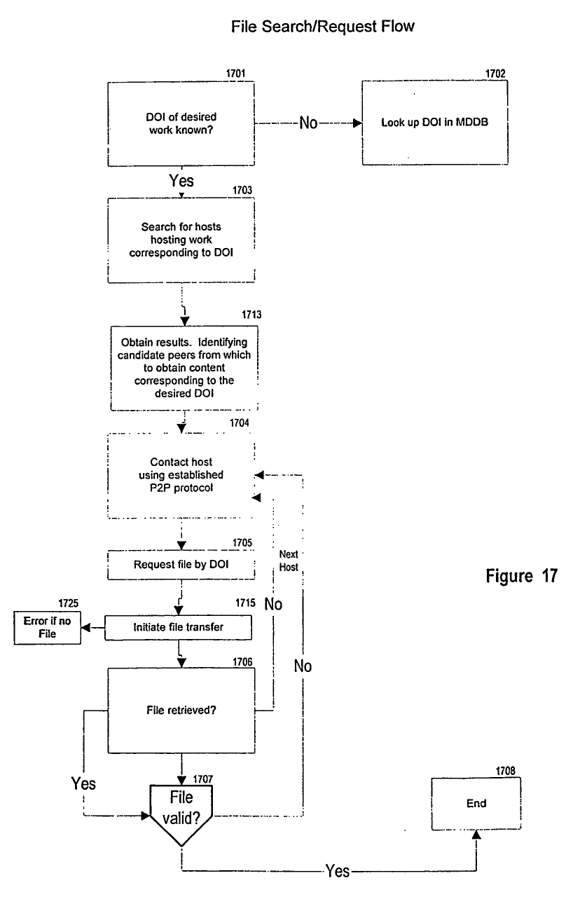

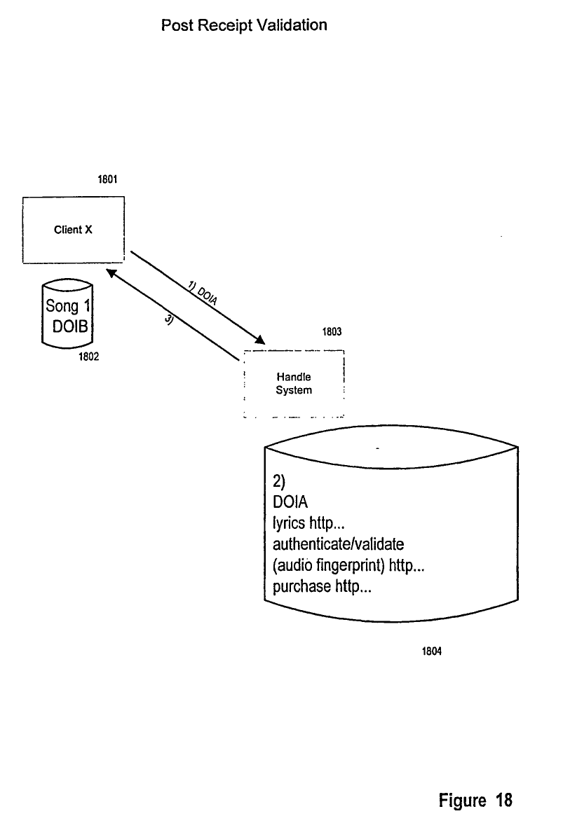

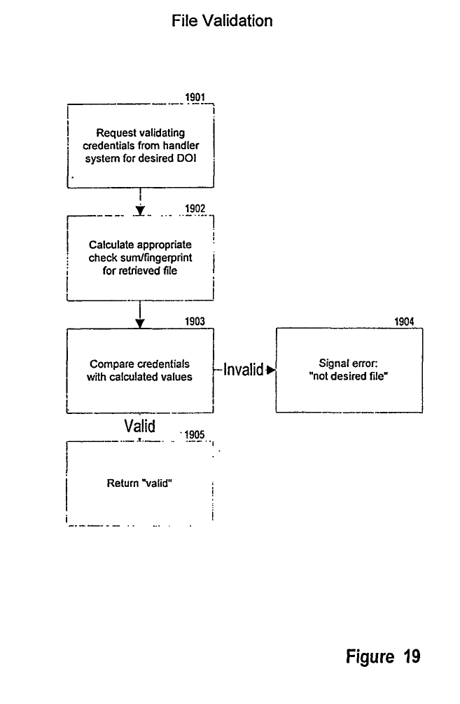

A DOI Enabled Peer-to-Peer (DE2P) module 135 is stored program code that is executed by the CPU. Generally, the DE2P catalogs (FIGS. 14 and 15), facilitates search requests (FIGS. 16 and 17), verifies obtained content from requests (FIGS. 18 and 19), obtains and provides information, between nodes on a communications network, and/or the like. The DE2P is a DOI enabled peer that enables searching, transferring, and verifying content across a P2P network based on DOIs. In one non-limiting example embodiment, the DE2P may include a P2P list collector to aggregate a node list 119e that is keyed to DOIs 119a. This database and/or data-structure aggregation of nodes lists copies of DOI referenced content and is searchable. The DE2P also provides the ability to validate content. Furthermore, the DE2P may be used to embed DOI values into content referenced by the DOI so that the content may be validated. The DE2P coordinates with the DE2P database to identify nodes satisfying search requests from other peers. A DE2P enabling access of information between nodes maybe be developed by employing standard development tools such as, but not limited to: C++, shell scripts, Java, Javascript, SQL commands, web application server extensions, Apache modules, Perl scripts, binary executables, and/or other mapping tools, and/or the like. In one non-limiting example embodiment, the DE2P employs a cryptographic server to encrypt and decrypt communications. The DE2P may catalog content, service requests, redirect requests, and much more. A DE2P module may communicate to and/or with other modules in a module collection, including itself, and/or facilities of the like. Most frequently, the DE2P module communicates internally and with other peers across a communications network with: a DE2P database, an IANM module, operating systems, other program modules, and/or the like. The DE2P may contain, communicate, generate, obtain, and/or provide program module, system, user, and/or data communications, requests, and/or responses.

Distributed DE2P

The functionality of any of the DE2P node controller components and/or functionalities may be combined, consolidated, and/or distributed in any number of ways to facilitate development and/or deployment. Similarly, the module collection may be combined in any number of ways to facilitate deployment and/or development. To accomplish this, one must simply integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load balancing data processing techniques. Furthermore, single instances may also be distributed across multiple controllers and/or storage devices; e.g., databases.

All program module instances and controllers working in concert may do so through standard data processing communication techniques.

The preferred DE2P controller configuration will depend on the context of system deployment. Factors such as, but not limited to, the capacity and/or location of the underlying hardware resources may affect deployment requirements and configuration. Regardless of if the configuration results in more consolidated and/or integrated program modules, results in a more distributed series of program modules, and/or results in some combination between a consolidated and/or distributed configuration, communication of data may be communicated, obtained, and/or provided. Instances of modules (from the module collection) consolidated into a common code base from the program module collection may communicate, obtain, and/or provide data. This may be accomplished through standard data processing techniques such as, but not limited to: data referencing (e.g., pointers), internal messaging, object instance variable communication, shared memory space, variable passing, and/or the like (intra-application communication).

If module collection components are discrete, separate, and/or external to one another, then communicating, obtaining, and/or providing data with and/or to other module components may be accomplished through standard data processing techniques such as, but not limited to: Application Program Interfaces (API) information passage; (distributed) Component Object Model ((D)COM), (Distributed) Object Linking And Embedding ((D)OLE), and/or the like), Common Object Request Broker Architecture (CORBA), process pipes, shared files, and/or the like (inter-application communication). Messages sent between discrete module components for inter-application communication or within memory spaces of a singular module for intra-application communication may be facilitated through the creation and parsing of a grammar. A grammar may be developed by using standard development tools such as lex, yacc, and/or the like, which allow for grammar generation and parsing functionality, which in turn may form the basis of communication messages within and between modules. Again, the preferable embodiment will depend upon the context of system deployment.

Finally, it is to be understood that the logical and/or topological structure of any combination of the module collection and/or the present invention as described in the figures and throughout are not limited to a fixed execution order and/or arrangement, but rather, any disclosed order is exemplary and all functional equivalents, regardless of order, are contemplated by the disclosure. Furthermore, it is to be understood that such structures are not limited to serial execution, but rather, any number of threads, processes, services, servers, and/or the like that may execute asynchronously, simultaneously, synchronously, and/or the like are contemplated by the disclosure.

IP Addressing

Users access communications networks through addresses. Addresses represent locations. Users traverse locations in a communications network hoping to find information. A common communications addressing scheme employs the IP address. The IP address may be likened to the real world by analogy to a street address. The IP address itself is a sequence of numbers, e.g., 209.54.94.99, and commonly has an associated name, e.g., www.contentdirections.com. A distributed database registry maintains the associated pairs of names and IP addresses and serves to resolve associated names into corresponding IP addresses. This allows people to remember and use names, e.g., www.report.com, instead of being forced to memorize and use a series of numbers, e.g., 209.54.94.99. These distributed databases assisting in the name resolution of IP addresses are commonly referred to as Domain Name Servers (DNS).

It is common for IP addresses to be embodied as Universal Resource Locators (URLs) that append even more navigation information into an address. Users may employ software to access information stored at URLs through the use of HTTP. An example is when a user specifies “http://www.report.com/reports/1999/IncomeStatement.html” in a web browser. Typically this further navigation information, i.e., “/reports/1999/IncomeStatement.html,” provides a specific storage location within a computer server. This further navigation location may be likened to a real world address more specific than a street address that includes information such as a company name, department, and room number. This further navigation location is typically not Handled or resolved by DNSs, but instead by an information server at the resolved IP address. For example, an information server at the resolved address of 123.123.123.123 for www.report.com would interpret and return information at a local location of “/reports/1999/IncomeStatement.html” within the server. An Information Server is a means for facilitating communications between a communication network and the computer server at a particular IP address. Commercial examples of an Information Server include Apache. An Information Server may be likened to a mail department for a business that further routes correspondence to appropriate locations within the business.

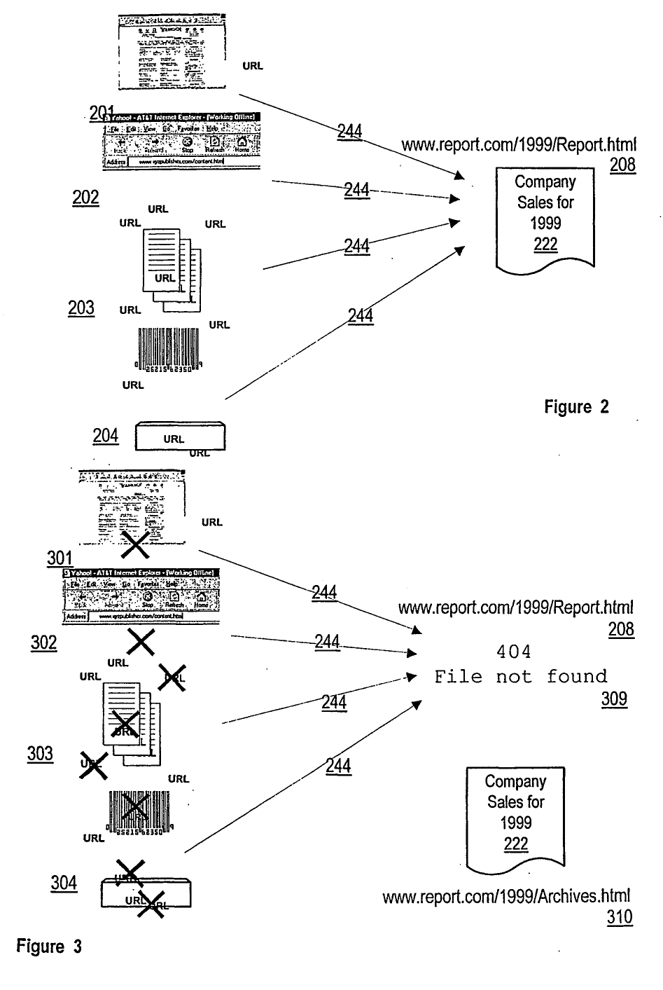

FIGS. 2 and 3 illustrate that IP addressing mechanisms do not maintain an association with information as it moves across a communications networks. Web page links generally employ HTTP, which in turn relies on IP addressing. Thus, URL links simply point to a location on a communication network and are not necessarily associated with any specific information. For example, a URL link referencing www.news.com will have different information associated between the URL and the information made available at the www.news.com location as information at the location is updated daily. In many instances, locations themselves may disappear as companies move information, move their operations, go out of business, etc.

For example, a report entitled “Company Sales for 1999” 222 existing at a location www.report.com/1999/Report.html 208 may be moved to www.reportarchives.com/1999/Old-report.html 310, e.g., because the information was sold from one entity to another, archived, or for many other reasons. The report at www.report.com/1999/Report.html 208 may have had 5 million web pages and URL links referencing the location 244, and when users attempt to access the information they may well receive a “404 File not found” error 309 because that location no longer exists and/or no longer contains the desired information. The error results because the DNSs were designed to always resolve users' requests to a location and because DNSs are not designed to maintain an association between URLs and a specific instantiation of information.

FIG. 2 depicts a web page 201, a user entered address 202, a document 203, and a memory device 204 all employing URLs and consequently IP addressing in an attempt to reference a piece of information (the report “Company Sales for 1999”) 222. Then in FIG. 2, the information 222 is moved from its original location 208 (for example at www.report.com/1999/Report.html) to a new location 310 of FIG. 2 (for example www.report.com/1999/Archives.html). In FIG. 3, this results in breaking 301-304 all the URLs 244 referencing the location and produces the dreaded “404 file not found” error 309 for all users and URLs making reference to the location (www.report.com/1999/Report.html) 208.

Handle System

Once a piece of information has been assigned a DOI and has been made available, the DOI system needs to be able to resolve what the user of the DOI wants to access. The technology that is used to manage the resolution of DOIs is better known as the “Handle System,” and will be described in more detail below. THE DOI HANDBOOK provides a general overview of basic DOIs. In a nutshell, the Handle System includes an open set of protocols, a namespace, and an implementation of the protocols. The protocols enable a distributed computer system to store Handles (such as DOIs) of digital content and resolve those Handles into the information necessary to locate and access the content, to locate and access information related to the content, or to locate and access (i.e., provide an interface to) services associated with the content. This associated information can be changed as needed to reflect the current state of the identified content without changing the DOI, thus allowing the name of the item to persist over changes of location and other state information. Combined with a centrally administered DOI registration agency, the Handle System provides a general-purpose, distributed global naming service for the reliable management of information and services on networks over long periods of time. It is important to note that throughout the present disclosure that “source,” “content” and/or “information” made accessible through the DOI system may comprise any identifiable content, source, information, services, transactions, and work of authorship, including articles, books, intangible objects, music albums, people, tangible physical objects, and/or the like further including selected discrete portions and/or combinations thereof. The accessible information may be a URL to an application that initiates a service, a transaction, provides a selection mechanism, and/or the like. In one non-limiting example, the DOI may even be associated with information identifying a human being such as a social security number, telephone number, and/or the like. In another non-limiting example, the DOI may be associated with software modules, programming “objects,” or any other network-based resource. Furthermore, a DOI can be used to represent most anything including the online representation of physical products (e.g., items currently identified by UPC or bar codes). In such an example, DOIs could resolve to the manufacturer's catalog page describing or offering the product, or even, in a multiple-resolution scenario, offer all services related to the object such as where to go to get the item repaired; where to find replacement parts; what the new or replacement product is; what kinds of pricing or leasing options are available, etc. Other example embodiments implementing DOIs include: representing different modules of software that may operate in distributed fashion across a communications network; telephone numbers for Voice-over-IP technology; gene sequences; medical records and/or other permanent records (DOIs will be especially useful with permanent records protected via encryption and/or other method that might invoke a certificate or decryption key); and/or the like. Another example embodiment for a DOI is to represent the permanent location of a temporary and/or dynamic value such as, but not limited to a current stock quote; current bid and offer prices (for stocks and/or any other kind of auction and/or exchange); a company's current annual report (versus different DOIs for different prior-year annual reports); and/or the like.

Users may access information through Digital Object Identifiers (DOIs). DOIs are associated with (i.e., are names for) information itself DOIs are instances of “Handles” and operate within the framework of the “Handle system.” A DOI allows for access to persistently associated information. The DOI is a string of characters followed by a separator further followed by a string of characters, e.g., 10.1065/abc123def. It should be noted and re-emphasized that although the present disclosure may make mention of specific sub-types of UNIs such as “URNs,” “DOIs” and “Handles,” the present disclosure applies equally well to the more generic types of UNIs, and as such, the present disclosure should be regarded as applying to UNIs in general where any UNI sub-type is mentioned, unless stated otherwise. Furthermore, although the Handle System, DOIs, and their supporting technologies and conventions, which are in use today, are a contemplated forum for the present invention, it should be noted that it is contemplated that the present invention may be applied to other forums based upon current and yet to be conceived conventions and systems.

DOIs

Users employing DOIs to access information know they will resolve and access only associated information. In contrast to URLs that reference locations, DOIs are names for information, which can be used to look up that information's location and other attributes, as well as related services. It is envisioned that information may be any information as well as any computer-readable files, including e-books, music files, video files, electronic journals, software, smaller portions and/or combinations of any of the aforementioned content as well. It should be noted that since the electronic content will be made available over a communications network, hereinafter this application refers to such available information as being published on a communications network.

A DOI is a permanent and persistent identifier given to a piece of information made available on a communications network and registered in an electronic form, so that even if the location (i.e., URL), format, ownership, etc. of the content or associated data changes, users will be able to access the associated data. DOIs, or Handles, may be distributed to users in lieu of a URL. A user may access information associated with a particular DOI by selecting or entering the DOI in a Handle-enabled web browser much like a URL hyperlink. Many types of browsers may be enabled by way of browser plug-in software such as the Handle System plug-in available from www.cnri.org. Such an attempt to access DOI associated information triggers an automated process to look up a resource's current location. The current location of the resource is associated with the resource's DOI in a centrally managed directory made available by the Handle System, which in turn directs the user (i.e., the user's web browser) to the resource's current location. This direction is often accomplished by returning a current URL associated with the selected DOI and corresponding information.

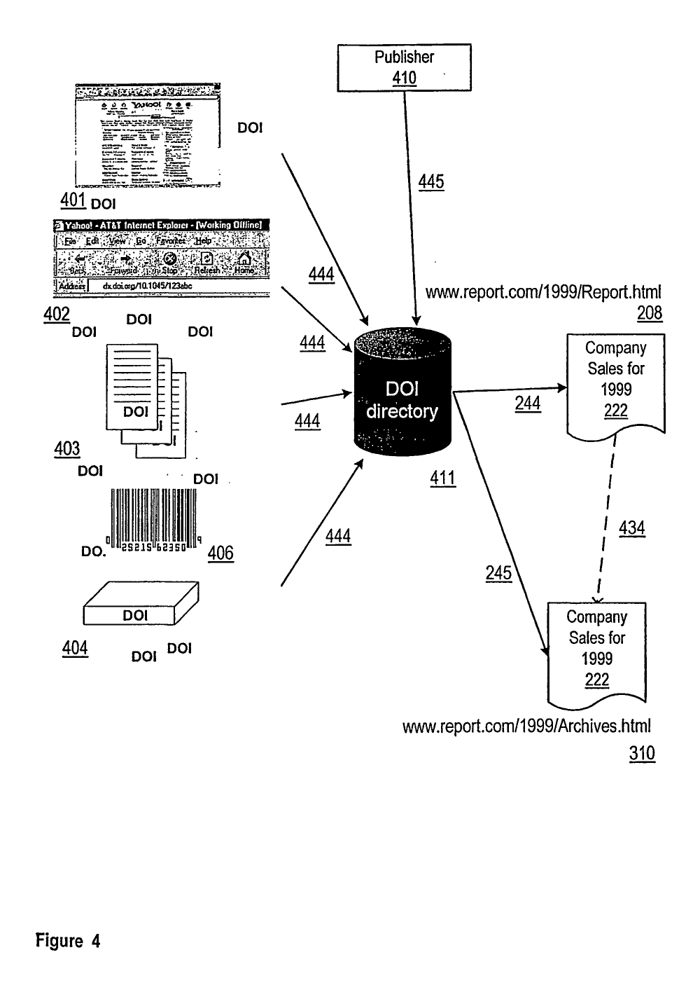

FIG. 4 illustrates the access of information through DOIs in contrast to FIGS. 2 and 3 above. Initially, the information (report of “Company Sales for 1999) 222 is given a DOI through a registration process. Instead of employing URLs, users reference 444 the information using the DOI through web pages 401, typed entry in a web browser 402, documents 403, devices 404, barcodes 406, and/or the like. When users engage the DOI links 444, they are resolved in a centralized DOI directory 411 and the requesting users are given a URL link 244 to the information's 222 initial location (www.report.com/1999/Report.html) 208. Upon the information being moved 434 from its initial location (www.report.com/1999/Report.html) 208 to a new location (www.report.com/1999/Archives.html) 310, the publisher of the information 410 would inform the DOI centralized directory 445 of the new location for the information by sending an updated URL 245 referencing the new location. Thereafter, if users 401-404 attempt to access the information through the DOI links 444, the DOI directory will properly provide the new location 310 by way of the updated URL 245.

As noted above, DOIs may not only be used to identify information, but also smaller portions thereof. For example, according to the DOI system, it is possible for a book to have one DOI, while each of its chapters would have other unique DOIs to identify them; furthermore, each figure in the book may have yet other unique DOIs to identify them. In other words, according to the DOI system, it is possible to identify information with variable granularity as desired by the content publishers. Furthermore, it is envisioned that just as Universal Product Codes (commonly expressed as ‘bar-codes’ on consumer products) allow, for example, a supermarket's cash registers, inventory computers, financial systems, and distributors to automate the supply chain in the physical world, the present disclosure provides a mechanism for employing DOIs to empower all kinds of agents in the world of electronic publishing to automate the sale of digital content (and the licensing of rights to that content) across the Internet in an efficient manner, since each piece of saleable content would have associated with it a globally unique DOI, which could be used as a product identification code in transactions between agents.

Handle Structure

The Handle System employs a predetermined set of policies for efficient and user-friendly utilization thereof, some of which of which are listed below. The use of the Handle System for DOI resolution should ideally be free to users, with the costs of operation of the system possibly borne by the publishers. All DOIs are to be registered with a global DOI registry. Registrants are responsible for the maintenance of state data and metadata relating to DOIs that they have registered. The syntax of the DOI follows a standardized syntax. In use, the DOI will be an opaque string (dumb number). DOI registration agencies will manage the assignment of DOIs, their registration and the declaration of the metadata associated with them.

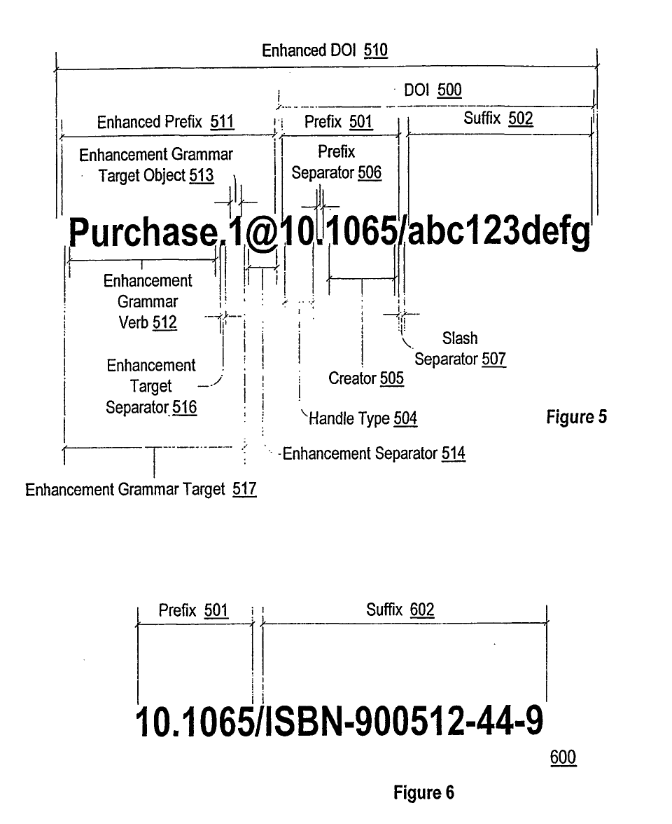

FIGS. 5 and 6 provide a schematic view of a Handle 600. A Handle 600 has two components, the prefix 501 and the suffix 602. The prefix 501 and the suffix 502 are separated by a forward slash 507. The Handle 500 may incorporate any printable characters from almost every major language written or used today. There is no specified limitation on the length of either the prefix 501 or the suffix 502. As a result, it is envisioned that there are an almost infinite number of Handles available. It is important to ensure that the combination of the prefix 501 and the suffix 502 is unique for supporting the integrity of the Handle System. Thus, the DOI registration agency will award a unique prefix 501 to a publisher. In one embodiment, the registration agency may put the responsibility on these publishers for ensuring that the suffix 502 assigned is unique as well. This may be achieved with a registration tool running on the user's client computer system. In another embodiment, the registration agency will ensure that the suffix 502 is unique by applying various suffix generation algorithms as discussed throughout this disclosure. The Registration Agency and the Handle System administrators will both verify uniqueness of any new Handle before depositing it in the Handle System. The Registration Agency deposits DOI records with the Handle System. The Handle System in turn services DOI resolution requests through a DOI directory.

The prefix 501 itself has two components separated by a prefix separator 506, which is a period. The first part of the Handle prefix is the Handle type 504. The second part of the Handle prefix is the Handle creator 505. The Handle type 504 identifies what type of Handle system is being used. When the Handle type 504 starts with a “10” the Handle is distinguished as being a DOI as opposed to any other implementation type of the Handle System. The next element of the prefix, separated by a period, is the Handle creator 505, which is a number (or string of characters) that is assigned to an organization that wishes to register DOIs. Together, these two elements 504 and 505 form the unique publisher prefix portion of the DOI. There is no limitation placed on the number of Handle (or specifically DOI) prefixes that any organization may choose to apply for. As a result, a publishing company, for example, might have a single DOI prefix 501, or might have a different one for each of its journals, or one for each of its imprints. While generally a prefix 501 may be a simple numeric string, the scope of the Handle System is not limited thereby. Thus, a prefix 501 may also utilize alphabetical characters or any other characters.

The suffix 502 is a unique string of alphanumeric characters, which, in conjunction with a particular prefix 501, uniquely identifies a piece of information. It should be appreciated that the combination of the prefix 501 for a publisher and the unique suffix 502 provided by the publisher avoids the need for the centralized allocation of DOI numbers. The suffix 502 may be any alphanumeric string that the publisher chooses, so long as it is unique among all suffixes registered in conjunction with the publisher's prefix.

FIG. 6 provides a view of another embodiment of the DOI 600, in which a textbook's ISBN number serves as the suffix 602. Consequently, where it is convenient, the publisher of the underlying content may choose to select as the suffix 602 any other identification code accorded to the original piece of content.

Enhanced DOI

FIG. 5 further illustrates an enhanced DOI 510 grammar. One non-limiting example embodiment of an enhancement to the DOI grammar is embodied as an enhanced prefix 511. However, it is fully contemplated that an alternative and/or complimentary enhanced suffix (not illustrated) may be similarly appended to the DOI 500. The enhanced prefix 511 is comprised of an enhancement grammar target 517 and enhancement separator 514, which is an “@” symbol, but it is understood any other character may be designated as the enhancement separator. The enhancement grammar target 517 may itself be any string of characters other than the enhancement separator 514. The enhancement grammar target 517 may be employed for the purpose of having the DOI 500 resolve to multiple versions of a specified information as will be described in greater detail throughout this disclosure. In a further enhanced embodiment, the enhancement grammar target 517 may itself be further comprised of an enhancement grammar verb 512 and enhancement grammar target object 513 separated by an enhancement target separator 516, e.g., a period. Of course the enhancement target separator 516 may be designated as any character(s). In one example embodiment, the enhancement grammar verb 512 acts as a modifier to select amongst a plurality of multiple resolution targets for a DOI, and the enhancement grammar target object 513 is a value passed to the target object and/or a Handle system resolution server for further action.

Handle System Metadata

A DOI 500 is merely an identification number that does not necessarily convey any information about its associated information. As a result, it is desirable to supplement the DOI with additional information regarding the addressed information to enable users to perform efficient and user-friendly searches for retrieving the desired content over a communications network. To allow easy identification of information, the present invention provides for the use of metadata, which is descriptive data about the identified information. While metadata may be any data-structure that is associated with a DOI, according to one embodiment, the metadata will be comprised of a few basic fields that can accurately and succinctly identify the published information. According to this embodiment, the metadata will comprise an identifier associated with the entity from a legacy identifier scheme such as the International Standard Book Number (ISBN) for a book, title of the published content, type of content being published (such as book, music, video, etc.), whether the content is original or a derivation, a primary author of the content, the role of the primary author in creating the content, the name of the publisher, and/or the like. As different types of content may require different metadata for describing it, one aspect of the DOI system envisions the use of different metadata for different types of content.

According to one example embodiment, metadata will be made available to any user of the DOI system to enable them to find the basic description of the entity that any particular DOI identifies. This basic description will allow the user to understand some basic things about the entity that published the content or the content itself.

As a result, to find out what information the DOI identifies, it is desirable to resolve it, and then review associated metadata because the DOI links the metadata with the content it identifies and with other metadata about the same or related content. In one embodiment, the metadata allows for the recognition of the information identified by the DOI 500 as well as its unambiguous specification. The metadata will also allow for the interaction between the information and other contents in the network (and with metadata about those entities).

DOI Information Access

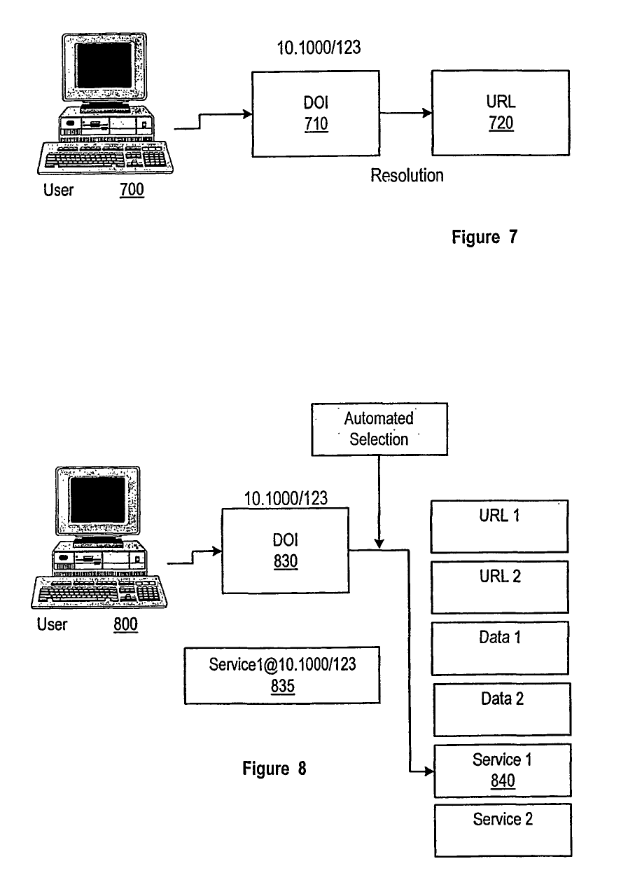

FIGS. 7 and 8 provide an overview of the resolution mechanism for allowing users to access the desired information by merely providing the DOI to the DOI Handle system. Resolution in the present context includes the submitting of an identifier to a network service and receiving in return one or more pieces of current information related to the identifier. According to one embodiment of the DOI system, shown in FIG. 7, the user uses her web browser 700 client to point to content identified by a particular DOI 710. This DOI 710 has only one URL associated with it, and must resolve to that URL. As a result, when the user makes a request for underlying content identified by a particular DOI 710, the user is directed to URL 720, where the desired content lies.

As such, this mechanism allows the location of the information to be changed while maintaining the name of the entity as an actionable identifier. If the publisher changes the location of the content, the publisher must merely update the DOI's entry in the Handle System database to ensure that the existing DOI 710 points to the new location of the content. As a result, while the location of the content has changed, the DOI remains the same and users are able to access the content from its new location by using the existing DOI.

FIG. 8 provides an overview of a DOI system where users may use a DOI for resolving a request for one piece of content, out of a plurality of available identical copies of the same piece of content that are identified by the same DOI, as well as the location of data about the piece of content, and services associated with the content (such as purchasing the content). Thus, the user uses the web browser 800 and provides the necessary DOI 830. The DOI 830 may be structured to describe the type of service desired 835. As a result, the DOI system is able to resolve the particular piece of content 840 that the user desires to access.

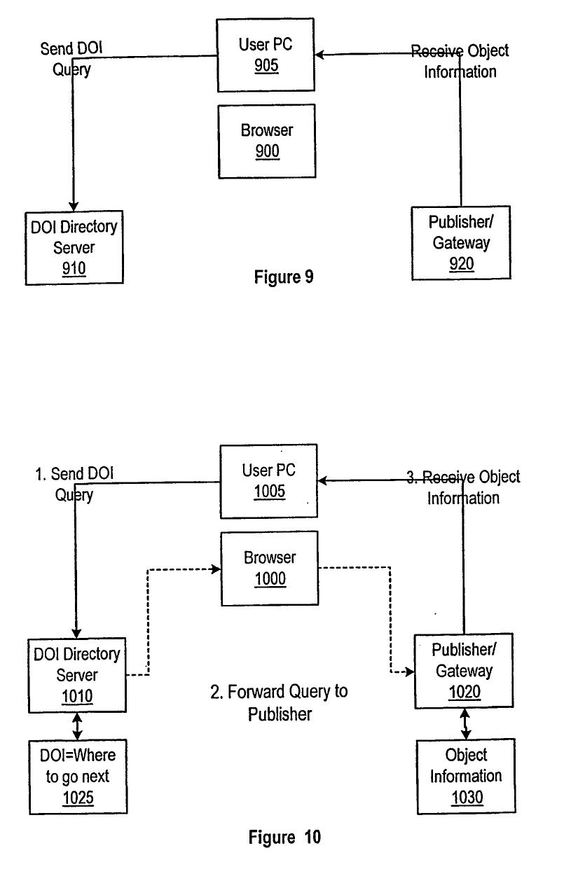

FIG. 9 provides an overview of the sequence of actions that a user performs to access information, in accordance with the present invention. Initially, the user launches the browser client 900 on a computing device 905, such as personal computer, personal digital assistant (PDA), and/or the like. The user engages the browser 900 to make a DOI query. The DOI query is forwarded to the DOI Directory Server 910 over a communications network. The system of the DOI Directory Server 910 examines the DOI against the entries stored therein and forwards the appropriate URL to the browser 900 on the user's computer 900, in a manner that is invisible to the user. As a result, the browser is pointed to the desired content on a server with the appropriate publisher information 920. Finally, upon receipt of the request from the user's browser, the publisher 920 forwards the desired information to the user, which may be accessed in the browser client 900.

FIG. 10 provides a more complete view of the sequence of actions that a user performs to access content information, as shown in FIG. 9. As noted above, the user launches the browser client 1000 on a computing device 1005. The user engages the browser 1000 to make a DOI query. The DOI query is forwarded to the DOI Directory Server 1010 over the communications network. The system of the DOI Directory Server 1010 examines the DOI against the entries stored therein. As a result of the checking of the DOI against the entries stored in the DOI Directory Server 1010, the DOI Directory Server 1010 determines where the DOI must lead the user 1025. The appropriate URL for the content is automatically forwarded to the user's browser 1000, without any intermediate intervention or action by the user. As a result, the browser 1000 is pointed to the appropriate publisher 1020 whose server is addressed by the underlying URL. The URL is used by the publisher's server 1020 to determine the exact location for content desired by the user, and the publisher's server 1020 forwards the appropriate content 1030 to the user.

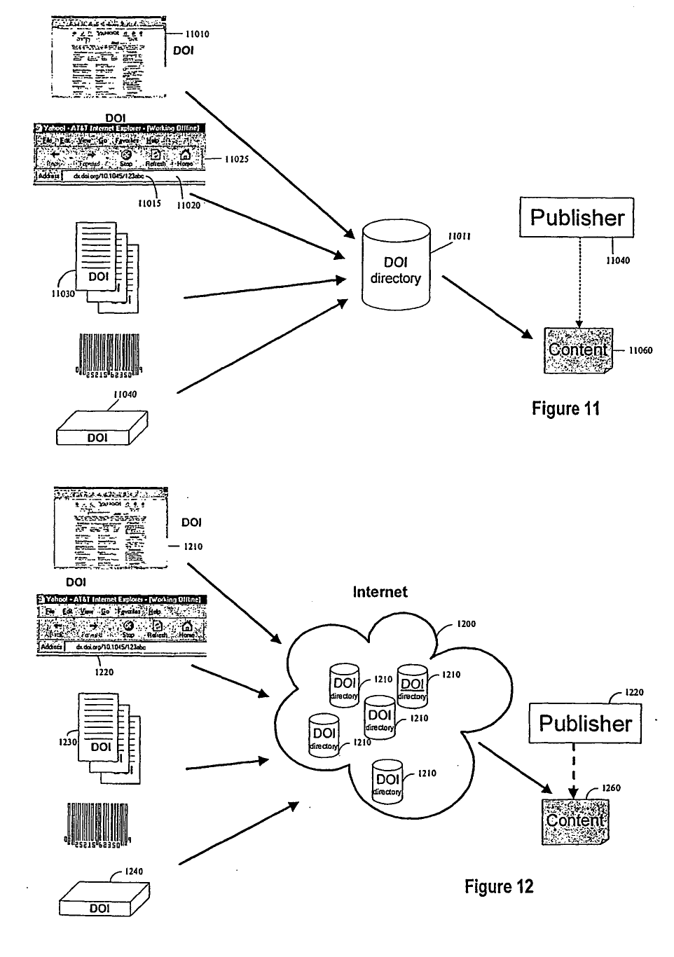

FIG. 11 provides an overview of some of the exemplary mechanisms for accessing information over a communications network by resolving a DOI to obtain the URL where the desired content is located, in accordance with the present invention. According to one embodiment, the user may directly provide the DOI and the DOI system retrieves and forwards the appropriate content to the user by simply linking to the appropriate URL. According to another embodiment, the user may provide information related to some of the fields included in the metadata, whereupon a DOI lookup service identifies the appropriate DOI, which in turn may be resolved to the desired content's location. As shown in FIG. 11, according to one embodiment, a search engine 11010 may be provided to a user. In one embodiment, the search engine is offered and disposed in communication with the registration agency's DOI and metadata database. In an alternative embodiment, a search engine such as www.google.com may be adapted to submit queries to the registration agency's databases. The user searches for the appropriate DOI by providing some identifying information to the search engine 11010. The search engine 11010 uses the identifying information provided and searches a database of metadata to retrieve the DOI associated with the provided metadata information. Thus the user conducting the search may be presented with returned DOIs from the metadata database and/or URLs resolved from said returned DOIs. The retrieved DOI is sent to the DOI directory 11011, which resolves the URL wherein the desired content is located by a publisher 11040. Finally, the user's browser is pointed to the appropriate content 11060.

According to another embodiment, the user may provide the DOI 11015 in the address window 11020 of a browser 11025. If the user's web browser is not capable of natively processing DOIs, then the DOI 11015 may contain the address of a proxy server for the DOI directory 11011, which in FIG. 11 is “dx.doi.org.” As a result, the browser is pointed to the DOI directory 11011 located at dx.doi.org, which resolves the URL at which the desired content is located by a publisher 11040 and points the user's browser thereto.

According to another embodiment, the DOI may be embedded in a document or some form of information 11030, whereupon clicking the DOI directs the user to the appropriate DOI directory 11011, which determines the URL at which the desired content is located and points the user's browser thereto.

According to another embodiment, the DOI may be provided on a memory 11040, such as a CD-ROM or a floppy disk, whereupon the memory may automatically, or upon being activated, direct the user to the appropriate DOI directory 11011, which resolves the URL at which the desired content is located and points the user's browser thereto.

According to yet another embodiment, the DOI may be provided in printed form to a user, who enters the DOI manually as above or by way of optical and/or mechanical peripheral input device.

FIG. 12 provides an overview of another embodiment of the exemplary mechanisms for retrieving information over a communications network, whereupon the DOI system resolves a DOI to obtain the URL where the desired information is located. According to this embodiment, a plurality of DOI directories 1210 exist as a distributed DOI directory and form a Handle System 1200. In one embodiment, the distributed DOI directory acts and responds to requests as if it were a singular directory 11011. Otherwise resolutions take place similarly as in FIG. 11.

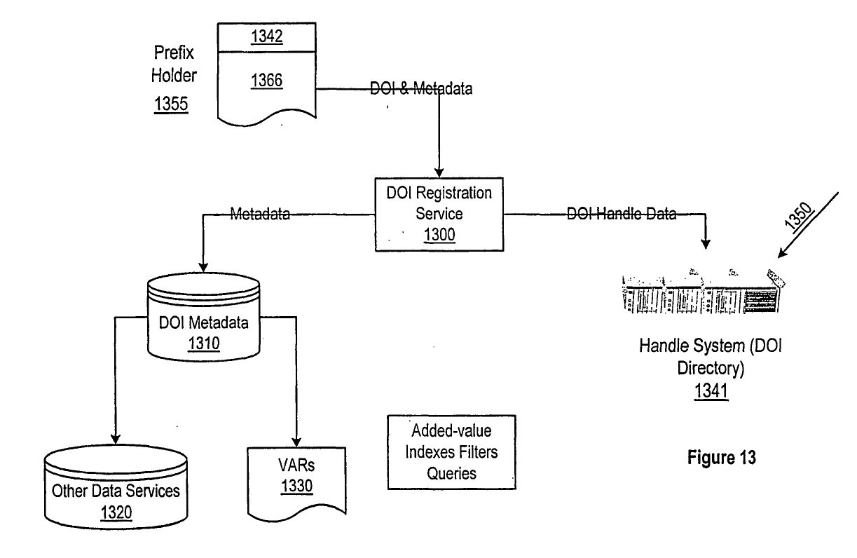

FIG. 13 provides an overview of an exemplary DOI system, in accordance with the present invention, wherein the publishers, the DOI registration service and the Handle System collaborate together to create an efficient DOI system. The prefix holder 1355 may submit information to a DOI registration service 1300 comprising a DOI 1342 and associated metadata 1366. The prefix holder who has already been assigned a unique prefix 501, requests that a suffix 502 be assigned to a piece of content 1366. The registration service 1300 is responsible for parsing and/or reformatting the user's streams of submitted information 1342, 1366 for subsequent deposit in a Handle system 1350 and/or metadata database 1310. As noted above, the scope of the content that can be addressed using a DOI is unlimited. As a result, the content 1366 may comprise any information and work of authorship, including articles, books, music albums, or selected discrete portions thereof. In addition to providing a DOI 500, the publisher 1342 collects metadata for the content 1366. The metadata may comprise the content's DOI 500, a DOI genre, an identifier, title, type, origination, primary agent, agent's role, and/or the like. It may also comprise listings of associated services having to do with the identified piece of content offered by various parties, such as the locations of web pages where a piece of content may be purchased online.

Once the publisher 1342 has assigned the suffix 502 to the content 1366 and collected the necessary metadata, the DOI 500 and the metadata are transmitted to the DOI registration service 1300. The DOI registration service 1300 maintains a database of DOIs 500, metadata of all the registered content 1366, as well as the URL at which the content 1366 is located. According to the present invention, the DOI registration service 1300 forwards the metadata to a metadata database 1310, 119c of FIG. 1, which may or may not be integrally maintained by the DOI registration service 1300.

The DOI registration service 1300 may use the collected metadata for providing it to other data services 1320 or for providing value added resources 1330 to the users. In addition, the DOI registration service 1300 sends the appropriate DOI Handle data to the Handle System 1350, which may comprise a plurality of DOI Directory Servers 1341.

Cataloguing System Data Flow

FIG. 14 depicts one non-limiting example embodiment of data flow for a cataloguing system effecting information access in a peer-to-peer environment. A peer 1401, e.g., DE2P, houses or is disposed in communication with a storage device 1403, which may contain content and/or information in varying forms such as, but not limited to, audio, metadata, software, structured documents, video, and/or other data formats. One category of content may have an embedded DOI, i.e., embedded DOI content (hereinafter ED content). In an alternative embodiment, content may be first encrypted with a DRM system and the DOI value may be appended to the encrypted content, thus remaining unencrypted. In another embodiment, the DOI value may be embedded into content, which is subsequently encrypted. Another category of content will not have DOIs embedded within but may have the attribute of having its location referenced by an associated DOI, i.e., DOI locale content (hereinafter DL content). Yet another category of content will be a copy of content from another location that was referenced by its associated DOI, i.e., carbon copied DOI content (hereinafter CCD content). Still another category of content will not be associated with any DOI, i.e., unreferenced DOI content (hereinafter UD content). These various categories of content may be combined in numerous ways.

Content may be registered with a handle system and have DOIs persistently refer to the location of content as established by the content's publisher. It is important to note that the location of content as established by the content's publisher will often be different from the copy stored at any given peer's 1401 storage device 1403 in a P2P network; i.e., most content on a P2P network will be CCD content rather than DL content. The reason for the likely greater availability of CCD content is that P2P networks promote copying content from locations other than those referenced or specified by a content's publisher. Furthermore, DOIs may be embedded into content in a number of ways such as, but not limited to: entering DOIs as values into known format metadata fields, e.g., values into MP3 tags; appending a DOI to the end of a file after an end-of-file (EOF) token; applying a watermark representing the DOI; and/or the like.

A peer 1401 is disposed in communication with a metadata database (MDDB) 1402 and a peer to peer list collector 1404. The peer “X” 1401 is generally disposed in communication with numerous other peers (not pictured), each of which may be similarly disposed in communication with a MDDB 1402 and P2P list collector 1404. Disposition of communication typically, although not necessarily, takes place across a communications network. Of course the functionality of the MDDB 1402 and/or P2P list collector 1404 may be distributed or centralized across numerous systems for performance enhancing reasons.

In one non-limiting example embodiment, the P2P list collector may itself be a peer similar to the peer depicted in box 1401, or alternatively it may be a server more tailored to serving requests of other peers. The P2P list collector 1404 is disposed in communication with a mass storage device 1405. In a slightly less distributed P2P model, the P2P list collector may be a local “super node” for example as is provided in a Morpheus P2P network or a centralized node for example as is provided in a Napster network. Such more centralized P2P list collectors obtain list catalogues of content 1403 from various peers 1401. In a completely decentralized model, all peers 1401 simply catalogue content stored in their local storage devices 1403, or alternatively, integrated the functionality of a P2P list collector 1404 into each peer 1401. In such decentralized P2P systems each peer 1401 may maintain a list of nodes 1405a itself.

In one non-limiting example of data flows for cataloguing, a peer 1401 first sends content metadata to a MDDB 1402 in the form of a query upon which the metadata database may search. The content metadata may be obtained from the content stored at the peer's storage device 1403 by extracting metadata information from files directly. Various techniques for mining metadata may be employed such as, but not limited to: obtaining embedded DOIs from the content, extracting metadata from tag information embedded in content (e.g., extracting artist, title, album information from an MP3 file), parsing a file searching for tokens (e.g., parsing a Microsoft Word file to identify its author and title), and/or the like. Upon sending the content metadata to the MDDB in the form of a query to ascertain an associated DOI for said content, the MDDB 1402 will provide the peer with an appropriately matching and associated DOI in response. The peer 1401 may discern and obtain associated DOIs for all its content that does not have DOIs imbedded within the content itself. If the content already had a DOI embedded, the peer may verify that the DOI returned by the MDDB corresponds. See FIGS. 18 and 19 for more detail on verification. Such verification will increase the fidelity of content made available across a P2P network. Such verification may take place for each item of content available on the peer's 1401 storage device 1403. Even if verification does not take place, access of CCD content may be tracked for statistical and other varied purposes.

The peer 1401 then may provide a P2P list collector 1404 with a message comprising: the peer's network location, e.g., an IP address, and a list of content available at the peer 1401 with associated DOIs. Thus, in one non-limiting example, peer X 1401 mines metadata from song 3 in its storage device 1403 and sends that to MDDB 1402, which in turn identifies and provides a query response identifying song 3 to be a copy of content referenced by DOIc. Peer X then associates Song 3 with DOIc. Peer X may make such an association in a number of ways such as, but not limited to: embedding DOIc within the content of Song 3, employing an internal data-structure (e.g., a table, (value paired linked) list. etc.) to associate DOIc with Song 3 within Peer X, and/or the like. In this way, each peer 1401 builds an internal list of all content available at its storage device 1403. Each entry referencing a content item will be accompanied by a DOI that either references the content and/or references content similar in substance elsewhere.

The P2P list collector may obtain numerous content list messages from numerous peers 1401 across a communications network that are reporting what content each peer has made available to other peers. The P2P list collector manages and contains a data-structure 1405a that has a list of DOIs and associated nodes on a network topology where information associated with the DOI is available. Standard data processing techniques may be employed to manage the list collector data-structure 1405 such as, but not limited to: a table with value pair fields keying nodes, e.g., represented by their IP addresses, containing content with a particular DOI reference and its DOI field; a (linked) list, and/or the like. In one non-limiting example embodiment, the P2P list collector 1404 provides a convenient mechanism to aggregate lists of available nodes that contain data associated with any particular DOI. In this way a P2P list collector 1405 can catalogue all the various nodes that are currently storing certain versions of content based on the content's DOI.

In one non-limiting example embodiment of a less centralized P2P network, upon compiling a list of content available on the peer 1401, the peer 1401 may send its content list to a P2P list collector 1404. Thereafter, the P2P list collector 1404 adds a reference to the peer 1401 within its data-structure 1405a associating the peer 1401 with various DOIs listed within the P2P list collector 1404 data-structure 1405a. In effect, this makes a particular peer 1401 available to other peers if and when those other peers execute a search for content with the P2P list collector. Thus, a P2P list collector 1404 maintains references to various peers hosing content available to other peers for downloading. A peer that conducts a search for a piece of content and obtains references back from the P2P list collector may then obtain a copy of the requested content from other node/peers referenced in the P2P list collector's 1404 data-structure 1405a. In an example search, a peer 1401 may query a P2P list collector for a copy of Song 3, i.e., content referenced by DOIb. The P2P list collector would inform Peer X 1401 that nodes/peers J and K are currently holding copies of Song 3. Thereafter, Peer X 1401 may initiate a download of a copy of Song 3 from peers J and/or K (not pictured). Furthermore, P2P list collector 1404 may then add Peer X as a node holding Song 3, i.e., DOIc, content within its data-structure 1405a. Referencing content by DOIs in such a manner has an advantage in that it there is a greater likelihood that a copy of the content will not be different or substandard from the original version of the content as referenced by its corresponding DOI. Such a referencing scheme has a further advantage in making it possible to download copies of the desired content with greater speed by downloading portions of the content simultaneously from multiple nodes known to hold accurate versions of copied content.

Cataloging System Logic Flow

FIG. 15 shows the logic flow of one non-limiting example embodiment of a cataloguing system for effecting information access in a peer-to-peer environment. Such a cataloguing system may be a component within a peer 1401, a P2P list collector 1404, and/or the like. The cataloguing system may be used to catalog content stored on the peer's storage device 1403 and is disposed in communication with a MDDB 1402.

Initially the cataloguing system determines if there is new content to catalog 1501. In one non-limiting example embodiment, a determination of if there is new content to catalogue may be made employing standard data-processing techniques to determine if new content items have been added and/or not accounted for, such as, but not limited to: scanning a database and/or directory structure for additions entered at times later than the last scan, compiling a list of entries in a database and/or directory structure and adding entries not matched with previous list compilations, and/or the like.

If there is no new content to catalog 1501, then the cataloguing system terminates 1502. If there is new content to catalog 1501, then for each piece of content available to a peer 1401, the cataloguing system then determines if the iterated content has a DOI imbedded within 1503. If the cataloguing system determines there is no DOI embedded within the content 1503, then the cataloguing system collects metadata from the content 1504. In one non-limiting example, the cataloguing system may collect the metadata from the content by employing parsing and examining the file based on known file types. For example, MP3 files are known to contain metadata with regard to the files' recording quality, name of artists who created the content, title of the music, and/or the like. In an alternative embodiment, the metadata describing the content may be obtained by the user supplying such information by way of a dialogue box GUI widget, and/or the like. Such metadata may be mined from a file and used to look up a DOI in a MDDB 1505. In this example, the MDDB acts as a metadata-DOI resolution server, i.e., resolving either metadata and/or DOIs into their respective counterparts. If no DOI is found based on the metadata query to the MDDB, then an error signal may be generated. In one example, the error signal may be used to notify the user that there is no known DOI associated with the new content. In an alternative embodiment, the error signal may also be used to activate other error handling modules. In an alternative embodiment, the cataloguing system may parse through content based on unknown file types looking for key fields and tokens such as artists, author, title and/or the like.

Upon determining that the content has an embedded DOI 1503, the cataloguing system retrieves the embedded DOI 1506. In an optional embodiment, the cataloguing system may then verify that the content stored locally that is being catalogued corresponds to verified content associated with a DOI 1511. In one non-limiting example embodiment, this verification may be achieved by requesting a verification from a handle system. The handle system verification may be achieved in a number of ways (see FIGS. 18 and 19 for more detail) including, but not limited to: submitting an enhanced DOI resolution request, e.g., verify.option@DOI, to the handle system, which may return and/or resolve to checksum, file size, digital certificate depending on the value of the option target; submitting a regular DOI resolution request that resolves to the content, which may then allow for a comparison of attributes between the resolved content and the locally available content; and/or the like forms of verification.

Upon obtaining the DOI 1506, 1505 and/or optionally verifying content 1511, the cataloguing system may then add obtained DOI 1506, 1505 to the local list of DOIs 1507. In one non-limiting example embodiment, the local list of DOIs may be a list of DOIs that are to be shared with a wide group of peers. Such sharing may be achieved by the peers by enabling the sending and receiving of content search requests and comparison of the search request to a data-structure to a local list of content. Upon looking up a DOI in an MDDB 1505 or upon retrieving an embedded DOI from an iterative content item 1506 and adding the DOIs to a local list 1507, the cataloguing system determines if there is more content to catalog 1508. If there is more content to catalog 1508, then the cataloguing system iterates and determines if there is a new content item to catalog 1501. If there is no more new content to catalog 1508, then the cataloguing system 1508 may submit a list of DOIs to the list collector 1509, 1404.

Handle System as a P2P List Collector

In one example alternative embodiment, the list collector 1404 taking the submission 1509 may be the handle system itself. In such an example, the peer 1401 (or even another P2P list collector 1404) may provide location addresses hosting CCD content associated with a DOI to a DOI registration server, i.e., an Information Access Registration Server (IARS). Thereafter, the IARS may add content-DOI resolution entries in its internal database that adds peers' location addresses as multiple resolution entries for any associated DOIs; such Peer Location Address (PLA) entries may also be handled by the IAMRS.

In one embodiment, PLA entries require as a deliberate act by the would-be hoster; a dialog box and or web form may be engaged to allow the peer to authorize PLA entry into the handle system through an IARS. In an another embodiment, PLA entry occurs passively by the peer by having a DOI embedded in the content that provides a PLA entry to an IARS. Such PLA entries employ the handle system registration system to provide additional hosts for content accessible through multiple resolution; i.e., in one non-limiting example embodiment the PLA entries themselves are requests to an IARS/IAMRS to register a new location for a piece of information associated with a particular DOI. PLA entries may be made anonymously and/or through privileged and managed facilities.

In a managed (either human-managed or automated) embodiment, only certain users are permitted to register themselves as hosts. In one non-limiting example embodiment, privileges for PLA entries are provided only to members of a specified group. In one non-limiting example embodiment, entry and or membership into a group automatically causes the peer to initiate a PLA entry into an IAMS. Group privileges may be assigned by various classifications such as, but not limited to: known user and group lists (e.g., those of operating systems such as Unix, Windows NT, and/or the like); peers with thresholds of continuous uptime (e.g., if a peer is available to other peers for more than some specified amount of time); peers with an availability of a specified quantity and/or quality of content (e.g., peers with content libraries above or below specified thresholds); peers with reliability of content (e.g., content verified by a Directory Quality Assurance Server testing); peers with quality of content provision (e.g., peers that provide transmission speeds above or below specified thresholds); peers with proven track records (e.g., peers may be rewarded for “good behavior” that have over or under a specified level of successful transmissions); peers with high selling records (e.g., peers may be rewarded for “good behavior” that have over or under a specified level of successful transmissions resulting in sales and/or payment for access to transmitted materials); peers with peer access credentials (e.g., a peer may provide a cookie, decryption key, file, password, validating credentials (see FIG. 19), and/or the like); and/or the like. In one example embodiment, a peer would check its local storage to determine if access credentials have been previously obtained, and if the access credentials are still valid. Examples of how to determine if access credentials are current may include, but are not limited to, examining expiration dates in the access credentials and obtaining new credentials after expiration dates; examining the number of accesses permitted in the access credentials and obtaining new credentials after the access limit has been reached; comparing the local access credentials with those resolved to by an associated DOI; and/or the like. In one example embodiment, peer access credentials may be obtained (e.g., purchased) through a digital rights clearinghouse, website, and/or the like; in such an embodiment if no peer access credentials were available locally or otherwise, the peer may be directed to a DRM system, a Digital Object Identifier Access Tracker (DOIAT), and/or the like:

It should be noted that such a cataloging P2P system (as described above in FIGS. 14 and 15) enables the DOI system of FIG. 8 and elsewhere to operate in a P2P environment. In other words, the propagation and reference to content is no longer limited to the control of publishers/owners of the content. This frees the content owner from having to position, maintain, and support many different locations to distribute and/or load balance availability of the content. Thus, the above cataloging system enables the DOI to become a mechanism for identifying and routing to different copies, i.e., CCD content, of the same object in a fully decentralized, un-managed P2P environment. For example, any end user who wants to host a copy of an item for public access could register themselves onto a P2P service that then updates a DOI record to point to their location. In a certain sense, such an example embodiment would enable the development of ad hoc content-DOI resolution servers, i.e., the handle system, by growing the database of DOIs and associated nodes (see 1405a of FIG. 14) within peers or P2P list collectors. In another embodiment, the public may modify entries in the handle system itself by adding entries of nodes that host copies of DOI referenced content, i.e., CCD content, into content-DOI resolution servers as multiple resolution node entries. This has the added benefit of converting CCD content into DL content for anyone using the handle system, and thus transforming the entire DOI system (of FIG. 8 and elsewhere) into an organic P2P system.

File Search and Request System Data Flow

FIG. 16 depicts a data flow diagram of a file search and request system effecting information access in a P2P environment. A peer 1601 is disposed in communication with an MDDB 1602. The peer is also disposed in communication with a P2P list collector 1606 that contains and/or has access to a storage device 1607. The P2P list collector 1606 storage device 1607 contains a data-structure that associates DOIs with peer nodes 1607a. The peer 1601 may also be disposed in communication with other peers. Each of the other peers, peer D 1603, peer G 1604 and peer F 1605 are similarly disposed in communication with the MDDB 1602 and the P2P list collector 1606 as is peer A 1601. In one non-limiting example, a user at peer A 1601 may submit a search to an MDDB 1602 by entering search criteria (e.g., artist name, title of work, recording quality, and/or the like) into a user interface widget, e.g., text field. The peer encapsulates the user's search request and submits it to the MDDB, which performs a query and returns query results to the peer 1601. The query results provided by the MDDB may be in the form of DOIs. Thereafter, a user at peer A 1601 may browse the list of query results from the MDDB and select content that the user desires. In one non-limiting example a user at peer A 1601 may select a DOI B. The selection is sent as a query request to a P2P list collector 1606. The P2P list collector 1606 in turn looks up peers associated with the use's desired content selection based on DOI B. In this example, DOI B is associated with peers D, F and G within the P2P list collector's lookup data-structure 1607a. In this example, the P2P list collector 1606 returns query results informing peer A that content associated with DOI B may be found on peers D, F and G. Thereafter, peer A initiates a file transfer request with peers D, F and G. The file transfer request and subsequent responses may be provided through standard transfer protocols such as, but not limited to: File Transfer Protocol, Hyper Text Transfer Protocol, TCP/IP packets, and/or the like. In an optional embodiment, peer A could request a check sum to validate that the files contained on peers D, F and G match and are the equivalent of information that is properly associated with DOI B as has already been discussed. In turn, each of the other peers D, F and G may make their own queries amongst themselves, with peer A 1601 and any other peers available across the P2P network.

File Search and Request System Logic Flow

FIG. 17 is a logic flow diagram for a file search and request system for effecting information access in a P2P environment. Initially, the search and request system determines if a DOI of desired content is known 1701. If the DOI for desired content is not known, the search and request system enables the user to look up the DOI in an MDDB based on metadata query tokens 1702.

Upon obtaining a DOI for desired content 1701, 1702, the search and request system submits a search request based on the obtained DOI to a P2P list collector to derive a list of hosts containing content. In one non-limiting example embodiment, the P2P list collector 1606 may derive the list of hosts by matching the obtained DOI with DOIs in its content catalogue data-structure 1607a for matching DOI entries and retrieving peer/nodes known to contain the desired content that correspond to the matched DOIs 1703. It is important to note that the P2P list collector 1607a may be varied in its role. In one non-limiting example embodiment, the P2P list collector is merely another peer identical in design and function to all other peers 1401. In an alternative embodiment, the P2P list collector 1404 is a centralized database accessed by all requesting peers 1401. In yet another alternative embodiment, the P2P list collector 1404 acts as a super node listing available peer nodes housing content to a limited group of peers. The preferred embodiment will vary and depend upon deployment requirements such as scalability, resource availability, and/or the like.

Upon querying a P2P list collector 1703, 1606, the search and request system will obtain results from the P2P list collector identifying candidate peers from which to obtain content corresponding to the desired DOI 1713. Upon obtaining a list of potential peers from which to obtain the desired work 1713, the search and request system will contact a peer using an established P2P protocol 1704. Non-limiting example protocols include, but are not limited to, TCP/IP, UDP, FTP, and/or the like. Upon contacting the peer and establishing a P2P protocol 1704, the desired content corresponding to a DOI is requested by DOI reference 1705. The request is made by submitting a DOI as a search term. The peer catalogs content in its storage device 1403 employing DOIs as key fields facilitating searches.

Upon establishing a request for a file by DOI reference 1705, a file transfer is initiated 1715. If the file is not available, an error message is generated 1725. In one non-limiting example embodiment, the search and request system determines if the file has been successfully retrieved 1706. If it has not been successfully retrieved, an alternative host is contacted and a P2P protocol connection is established with the alternative host 1704. In yet another alternative embodiment, a search and request system may contact multiple hosts simultaneously establishing P2P protocols with each of the multiple hosts; in this way it may engage in multiple transfers of various portions of the same requested file to increase the file transfer rate of said file.

Upon determining that the requested file has been successfully retrieved 1706, the search and request system determines if the retrieved file is valid 1707. In one non-limiting example embodiment, the file is determined to be valid by comparing it against a check sum based on the file's size and/or other attributes with a check sum stored in the handle system's metadata database regarding content associated with that particular DOI. Upon determining that the transferred file is valid, flow terminates 1708. If the file is determined to be invalid 1707, the search and request system may initiate a new P2P protocol with an alternative peer to obtain a valid file. Iteration will continue in such a manner until the user desires the cancellation of such file transfers and/or successfully retrieves a file.

Post Receipt Validation System Data Flow

FIG. 18 illustrates a data flow diagram for a post-receipt validation system for effecting information access in a P2P environment. A peer 1801 is disposed in communication with a handle system 1803. The peer provides a DOI to resolve with the handle system 1803. The peer may include a mass storage device 1802 and/or the like that may contain content with embedded DOIs, e.g., Song 1 with DOIb. The handle system may resolve DOIs with any associated information and also may resolve a DOI with metadata in a MDDB. Metadata may include items such as lyrics, authentication information, audio fingerprints, HTTP locations for content, HTTP locations for purchasing content and/or the like. The handle system provides the peer 1801 with a resolution location from which it may obtain content, metadata, services, and/or the like. In one non-limiting example embodiment, the handle system will resolve to content, metadata, services, and/or the like based on an enhanced DOI; e.g., validate@DOIa would resolve to validation information associated with DOIa. It should be noted that the post-receipt validation system may be integrated into a peer 1401.

File Receipt Validation System Logic Flow

FIG. 19 depicts a logic flow diagram for a file receipt validation system for effecting information access in a P2P environment. Initially, the file validation system requests validating credentials from the handle system for any desired DOI 1901.

Validating credentials may include, but are not limited to: checksums, digital certificates, digital fingerprints, encryption keys, comparison of content/tags (e.g., comparing the author, title, publisher, etc. tags embedded within CCD content item and that of a DL content item), content itself (e.g., extracting portions of a DL content item for comparison with a CCD content item), passwords, and/or the like—including DOIs which may denote credentials such as any of the preceding. In one non-limiting example embodiment, specific requests for authentication and/or validation forms may be enabled through the use of an enhanced DOI grammar and through multiple resolution of DOIs. For example, a request may be: submitted as an enhanced DOI resolution request, e.g., verify.option@DOI, to the handle system, which may return and/or resolve to checksum, file size, digital certificate depending on the value of the option target; submitted as a regular DOI resolution request that resolves to the content, which may then allow for a comparison of attributes between the resolved content and the locally available content; and/or the like forms of verification.

Upon obtaining validating credentials from the handle system 1901, the file validation system may then employ authentication and validation techniques to locally establish the authenticity and/or validation of a retrieved file 1902. In one non-limiting example embodiment, the file validation system will employ a checksum on the locally retrieved file and compare it with the check sum returned from the handle system. In an alternative non-limiting example embodiment, the file validation system will compare the fingerprint retrieved from the locally stored file and that from the handle system. In yet another alternative embodiment, the file validation system will decrypt a supplied and/or embedded digital certificate and compare it with a digital certificate obtained from a validation authority.

Upon calculating the appropriate authentication and validation information, the file validation system will compare the obtained credentials with the calculated values 1903. If the file validation system determines that the compared credential values do not match the calculated values, the file will be deemed to be invalid and a signal error will be generated 1904. However, if the calculated authentication and/or validation values match the values obtained from the handle system, the retrieved file will be determined to be valid 1903 and a signal indicating that the file is valid will be generated 1905. It should be noted that the file receipt validation system may be integrated into a peer 1401.

It should be understood that the above description is only representative of illustrative embodiments. For the convenience of the reader, the above descriptions have focused on a representative sample of all possible embodiments, a sample that teaches the principles of the invention. The description has not attempted to exhaustively enumerate all possible variations. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that the embodiments and variations shown and described herein are merely illustrative of the principles of this invention and that various modifications may be implemented without departing from the scope and spirit of the invention.

What is claimed is:

1. A method for using a peer to access information, comprising:
determining if there is new information to catalog;
embedding an unique, persistent, and universal name identifier (UPUNI) corresponding to the new information within the new information, if the new information has no embedded UPUNI;
mining source identifying data as metadata from within new information and querying a database holding UPUNI and metadata (MUPUNI database) with the mined metadata for an UPUNI corresponding to the mined metadata, if the new information has no embedded UPUNI, wherein the UPUNI is obtained in response to the metadata query to the MUPUNI database;
resolving a new information's UPUNI to location addresses for accessing originating versions of the information;
verifying the new information against information at location addresses resolved by the UPUNI, if verification is desired;
adding an entry of the new information's availability into a local data-structure to catalog information items available on a peer for transmission to others, wherein the entry into the local data-structure is keyed by UPUNI;
providing data from the local catalog data-structure to a peer to aggregate catalog data into a centralized data-structure.

2. A method for using a peer to catalog information, comprising:
mining source identifying data as metadata from within new information and querying a database holding unique, persistent, and universal name identifier (UPUNI) and metadata (MUPUNI database) with the mined metadata for an UPUNI corresponding to the mined metadata, if the new information has no embedded UPUNI;
resolving a new information's UPUNI to location addresses for accessing originating versions of the information;
adding an entry of the new information's availability into a local data-structure to catalog information items available on a peer for transmission to others.

3. The method of claim 2, wherein the local data-structure is in an UPUNI resolution system.

4. The method of claim 2, further comprising:
determining if there is new information to catalog.

5. The method of claim 2, further comprising:
determining if the new information contains an embedded unique, persistent, and universal name identifier (UPUNI).

6. The method of claim 2, further comprising:
embedding an UPUNI corresponding to the new information within the new information, if the new information has no embedded UPUNI.

7. The method of claim 6, wherein the corresponding UPUNI is obtained in response to the metadata query to the MUPUNI database.

8. The method of claim 2, wherein the resolution is a request to a digital rights clearinghouse to enable access of the information.

9. The method of claim 8, wherein the request is achieved by way of an enhanced DOI grammar request.

10. The method of claim 2, further comprising:
verifying the new information against information at location addresses resolved by the UPUNI.

11. The method of claim 10, wherein the verification is achieved by way of an enhanced DOI grammar request.

12. The method of claim 2, wherein the entry into the local data-structure includes location addresses of peers making the information available.

13. The method of claim 2, wherein the entry into the local data-structure is keyed by UPUNI.

14. The method of claim 2, wherein the entry into the local data-structure is of the UPUNI, if the new information is verified the information at a location referenced by the UPUNI.

15. The method of claim 2, wherein the entry into the local data-structure occurs only if the new information is verified against information at location addresses resolved by the UPUNI.

16. The method of claim 2, further comprising:
providing data from the local catalog data-structure to a peer to aggregate catalog data into a centralized data-structure.

17. The method of claim 16, wherein the aggregating peer catalogs provided information items including a reference to peers that provide the data from their local catalog.

18. The method of claim 16, wherein the centralized data-structure may be queried for local peers.

19. The method of claim 16, wherein the centralized data-structure may be queried for information items.

20. The method of claim 16, wherein the aggregating peer may provide query results of local peers holding requested information items.

21. The method of claim 16, wherein the aggregating peer may provide query results of information items available at the local peers.

22. The method of claim 16, wherein there may be multiple aggregating peers aggregating catalog data.

23. The method of claim 16, wherein there may be multiple centralized data-structures for aggregating catalog data.

24. The method of claim 16, wherein the centralized data-structure is in an UPUNI resolution system.

25. A method for using a peer to access information, comprising:
obtaining a request for desired information;
querying a database holding unique, persistent, and universal name identifiers (UPUNI) and metadata (MUPUNI database) for desired information, if an associated UPUNI is unknown for the desired information, wherein the MUPUNI query is based on metadata query tokens;
obtaining an UPUNI for the desired information, wherein the UPUNI is obtained from query results from the MUPUNI database, if an associated UPUNI is unknown for the desired information;
searching for peers with the desired information that corresponds to the obtained UPUNI;
obtaining search results;
identifying candidate peers from which to obtain desired information that corresponds to the obtained UPUNI;
requesting desired information from at least one candidate peer;
obtaining the desired information from at least one candidate peer;
verifying the obtained information against information at a location address resolved by the obtained UPUNI.

26. A method for using a peer to access information, comprising:
searching for peers with an obtained unique, persistent, and universal name identifiers (UPUNI) for desired information, which corresponds to the obtained UPUNI;
obtaining search results;
identifying candidate peers from which to obtain desired information that corresponds to the obtained UPUNI;
requesting desired information from a candidate peer;
obtaining the desired information from the candidate peer.

27. The method of claim 26, further comprising:
obtaining a request for desired information.

28. The method of claim 27, wherein the request for desired information is made with an UPUNI associated with the desired information.

29. The method of claim 27, wherein the request for desired information is made with metadata query tokens regarding the desired information, the metadata query tokens being sent to the MUPUNI and resolved into an UPUNI.

30. The method of claim 26, further comprising:
querying an (UPUNI) and metadata database (MUPUNI database) for desired information, if an associated UPUNI is unknown for the desired information.

31. The method of claim 30, wherein the MUPUNI query is based on metadata query tokens.

32. The method of claim 30, wherein the UPUNI is obtained from query results from the MUPUNI database.

33. The method of claim 26, further comprising:
obtaining an UPUNI for desired information, if an associated UPUNI is unknown for the desired information.

34. The method of claim 33, wherein the UPUNI is obtained from a reference.

35. The method of claim 34, wherein the reference is a hyperlink.

36. The method of claim 26, wherein the searched for peers is conducted on an UPUNI resolution system.

37. The method of claim 26, wherein the searched for peers is conducted on other peers.

38. The method of claim 26, wherein the searched for peers is conducted on peer-to-peer list collector.

39. The method of claim 26, wherein the searched for peers host the desired information.

40. The method of claim 26, wherein the searched for peers reference the desired information.

41. The method of claim 26, wherein the peer request for desired information is made to a plurality of candidate peers.

42. The method of claim 26, wherein the desired results are obtained from a plurality of candidate peers.

43. The method of claim 26, further comprising:
verifying the obtained information against information at a location address resolved by the obtained UPUNI.

44. The method of claim 43, wherein the verification is achieved by way of an enhanced DOI grammar request.

45. A method for using a peer to validate information, comprising:
identifying information to be validated;
obtaining an unique, persistent, and universal name identifier (UPUNI) for the identified information;
requesting validating credentials for the identified information from an UPUNI resolution system with the obtained UPUNI;
obtaining the requested validating credentials;
comparing a representative digital verification value against the obtained validating credentials,
wherein the representative digital verification values may include checksums, comparisons of information, comparisons of information tags, digital certificates, digital fingerprints, encryption keys, the identified information itself, and passwords, and
wherein the identified information is validated if the comparison against obtained validating credentials results in matching values.

46. A method for using a peer to validate information, comprising:
obtaining an unique, persistent, and universal name identifier (UPUNI) for identified information;
requesting validating credentials for the identified information from an UPUNI resolution system with the obtained UPUNI;
obtaining the requested validating credentials;
comparing a representative digital verification value against the obtained validating credentials.

47. The method of claim 46, wherein the UPUNI is embedded within the information.

48. The method of claim 46, wherein the UPUNI is resolved from an UPUNI and metadata database.

49. The method of claim 46, wherein the UPUNI is provided by a user.

50. The method of claim 46, wherein the validating credentials request is achieved by way of an enhanced DOI grammar request.

51. The method of claim 46, wherein validating credentials may include: checksums, digital certificates, digital fingerprints, encryption keys, information itself, passwords, values resulting from comparisons of information, and values resulting from comparisons of information tags.

52. The method of claim 46, further comprising:
computing a representative digital verification value from the identified information.

53. The method of claim 52, wherein the representative digital verification value computation may include: comparisons of information, comparisons of information tags, generation of checksums, generation of digital certificates, generation of digital fingerprints, generation of encryption keys, provision of passwords, and selecting portions of the identified information itself.

54. The method of claim 53, wherein the selected portions may include the entirety of the identified information itself.

55. The method of claim 46, wherein the representative digital verification values may include: checksums, digital certificates, digital fingerprints, encryption keys, the identified information itself, passwords, values resulting from comparisons of information, and values resulting from comparisons of information tags.

56. The method of claim 46, wherein the identified information is validated if the comparison against obtained validating credentials results in matching values.

57. A memory for access by a program module to be executed on a processor, comprising:
a data structure stored in the memory, the data structure having associated data types, including,
a data type to store a unique, persistent, and universal name identifier (UPUNI);
a data type to store location addresses of peers with information substantively similar to information referenced by the UPUNI.

58. A system for using a peer to access information, comprising:
means to determine if there is new information to catalog;
means to embed an unique, persistent, and universal name identifier (UPUNI) corresponding to the new information within the new information, if the new information has no embedded UPUNI;
means to mine source identifying data as metadata from within new information and querying a database holding UPUNI and metadata (MUPUNI database) with the mined metadata for an UPUNI corresponding to the mined metadata, if the new information has no embedded UPUNI, wherein the UPUNI is obtained in response to the metadata query to the MUPUNI database;
means to resolve a new information's UPUNI to location addresses for accessing originating versions of the information;
means to verify the new information against information at location addresses resolved by the UPUNI, if verification is desired;
means to add an entry of the new information's availability into a local data-structure to catalog information items available on a peer for transmission to others, wherein the entry into the local data-structure is keyed by UPUNI;
means to provide data from the local catalog data-structure to a peer to aggregate catalog data into a centralized data-structure.

59. A system for using a peer to catalog information, comprising:
means to mine source identifying data as metadata from within new information and querying a database holding unique, persistent, and universal name identifier (UPUNI) and metadata (MUPUNI database) with the mined metadata for an UPUNI corresponding to the mined metadata, if the new information has no embedded UPUNI;
means to resolve a new information's UPUNI to location addresses for accessing originating versions of the information;
means to add an entry of the new information's availability into a local data-structure to catalog information items available on a peer for transmission to others.

60. The system of claim 59, wherein the local data-structure is in an UPUNI resolution system.

61. The system of claim 59, further comprising:
means to determine if there is new information to catalog.

62. The system of claim 59, further comprising:
means to determine if the new information contains an embedded unique, persistent, and universal name identifier (UPUNI).

63. The system of claim 59, further comprising:
means to embed an UPUNI corresponding to the new information within the new information, if the new information has no embedded UPUNI.

64. The system of claim 63, wherein the corresponding UPUNI is obtained in response to the metadata query to the MUPUNI database.

65. The system of claim 59, wherein the resolution is a request to a digital rights clearinghouse to enable access of the information.

66. The system of claim 65 wherein the request is achieved by way of an enhanced DOI grammar request.

67. The system of claim 59, further comprising:
means to verify the new information against information at location addresses resolved by the UPUNI.

68. The system of claim 67, wherein the verification is achieved by way of an enhanced DOI grammar request.

69. The system of claim 59, wherein the entry into the local data-structure includes location addresses of peers making the information available.

70. The system of claim 59, wherein the entry into the local data-structure is keyed by UPUNI.

71. The system of claim 59, wherein the entry into the local data-structure is of the UPUNI, if the new information is verified the information at a location referenced by the UPUNI.

72. The system of claim 59, wherein the entry into the local data-structure occurs only if the new information is verified against information at location addresses resolved by the UPUNI.

73. The system of claim 59, further comprising:
means to provide data from the local catalog data-structure to a peer to aggregate catalog data into a centralized data-structure.

74. The system of claim 73, wherein the aggregating peer catalogs provided information items including a reference to peers that provide the data from their local catalog.

75. The system of claim 73, wherein the centralized data-structure may be queried for local peers.

76. The system of claim 73, wherein the centralized data-structure may be queried for information items.

77. The system of claim 73, wherein the aggregating peer may provide query results of local peers holding requested information items.

78. The system of claim 73, wherein the aggregating peer may provide query results of information items available at the local peers.

79. The system of claim 73, wherein there may be multiple aggregating peers aggregating catalog data.

80. The system of claim 73, wherein there may be multiple centralized data-structures for aggregating catalog data.

81. The system of claim 73, wherein the centralized data-structure is in an UPUNI resolution system.

82. A system for using a peer to access information, comprising:
means to obtain a request for desired information;
means to query a database holding unique, persistent, and universal name identifiers (UPUNI) and metadata (MUPUNI database) for desired information, if an associated UPUNI is unknown for the desired information, wherein the MUPUNI query is based on metadata query tokens;
means to obtain an UPUNI for the desired information, wherein the UPUNI is obtained from query results from the MUPUNI database, if an associated UPUNI is unknown for the desired information;
means to search for peers with the desired information that corresponds to the obtained UPUNI;
means to obtain search results;
means to identify candidate peers from which to obtain desired information that corresponds to the obtained UPUNI;
means to request desired information from at least one candidate peer;
means to obtain the desired information from at least one candidate peer;
means to verify the obtained information against information at a location address resolved by the obtained UPUNI.

83. A system for using a peer to access information, comprising:
means to search for peers with an obtained unique, persistent, and universal name identifiers (UPUNI) for desired information, which corresponds to the obtained UPUNI;
means to obtain search results;
means to identify candidate peers from which to obtain desired information that corresponds to the obtained UPUNI;
means to request desired information from a candidate peer;
obtaining the desired information from the candidate peer.

84. The system of claim 83, further comprising:
obtaining a request for desired information.

85. The system of claim 84, wherein the request for desired information is made with an UPUNI associated with the desired information.

86. The system of claim 84, wherein the request for desired information is made with metadata query tokens regarding the desired information, the metadata query tokens being sent to the MUPUNI and resolved into an UPUNI.

87. The system of claim 83, further comprising:
means to query an (UPUNI) and metadata database (MUPUNI database) for desired information, if an associated UPUNI is unknown for the desired information.

88. The system of claim 87, wherein the MUPUNI query is based on metadata query tokens.

89. The system of claim 87, wherein the UPUNI is obtained from query results from the MUPUNI database.

90. The system of claim 83, further comprising:
means to obtain an UPUNI for desired information, if an associated UPUNI is unknown for the desired information.

91. The system of claim 90, wherein the UPUNI is obtained from a reference.

92. The system of claim 91, wherein the reference is a hyperlink.

93. The system of claim 83, wherein the searched for peers is conducted on an UPUNI resolution system.

94. The system of claim 83, wherein the searched for peers is conducted on other peers.

95. The system of claim 83, wherein the searched for peers is conducted on peer-to-peer list collector.

96. The system of claim 83, wherein the searched for peers host the desired information.

97. The system of claim 83, wherein the searched for peers reference the desired information.

98. The system of claim 83, wherein the peer request for desired information is made to a plurality of candidate peers.

99. The system of claim 83, wherein the desired results are obtained from a plurality of candidate peers.

100. The system of claim 83, further comprising:
means to verify the obtained information against information at a location address resolved by the obtained UPUNI.

101. The system of claim 100, wherein the verification is achieved by way of an enhanced DOI grammar request.

102. A system for using a peer to validate information, comprising:
means to identify information to be validated;
means to obtain an unique, persistent, and universal name identifier (UPUNI) for the identified information;
means to request validating credentials for the identified information from an UPUNI resolution system with the obtained UPUNI;
means to obtain the requested validating credentials;
means to compare a representative digital verification value against the obtained validating credentials,
wherein the representative digital verification values may include checksums, comparisons of information, comparisons of information tags, digital certificates, digital fingerprints, encryption keys, the identified information itself, and passwords, and
wherein the identified information is validated if the comparison against obtained validating credentials results in matching values.

103. A system for using a peer to validate information, comprising:
means to obtain an unique, persistent, and universal name identifier (UPUNI) for identified information;
means to request validating credentials for the identified information from an UPUNI resolution system with the obtained UPUNI;
means to obtain the requested validating credentials;
means to compare a representative digital verification value against the obtained validating credentials.

104. The system of claim 103, wherein the UPUNI is embedded within the information.

105. The system of claim 103, wherein the UPUNI is resolved from an UPUNI and metadata database.

106. The system of claim 103, wherein the UPUNI is provided by a user.

107. The system of claim 103, wherein the validating credentials request is achieved by way of an enhanced DOI grammar request.

108. The system of claim 103, wherein validating credentials may include: checksums, digital certificates, digital fingerprints, encryption keys, information itself, passwords, values resulting from comparisons of information, and values resulting from comparisons of information tags.

109. The system of claim 103, further comprising:
computing a representative digital verification value from the identified information.

110. The system of claim 109, wherein the representative digital verification value computation may include: comparisons of information, comparisons of information tags, generation of checksums, generation of digital certificates, generation of digital fingerprints, generation of encryption keys, provision of passwords, and selecting portions of the identified information itself.

111. The system of claim 110, wherein the selected portions may include the entirety of the identified information itself.

112. The system of claim 103, wherein the representative digital verification values may include: checksums, digital certificates, digital fingerprints, encryption keys, the identified information itself, passwords, values resulting from comparisons of information, and values resulting from comparisons of information tags.

113. The system of claim 103, wherein the identified information is validated if the comparison against obtained validating credentials results in matching values.

114. A program stored on a medium readable by a processor, the program, comprising:
a module to determine if there is new information to catalog;
a module to embed an unique, persistent, and universal name identifier (UPUNI) corresponding to the new information within the new information, if the new information has no embedded UPUNI;
a module to mine source identifying data as metadata from within new information and querying a database holding UPUNI and metadata (MUPUNI database) with the mined metadata for an UPUNI corresponding to the mined metadata, if the new information has no embedded UPUNI, wherein the UPUNI is obtained in response to the metadata query to the MUPUNI database;
a module to resolve a new information's UPUNI to location addresses for accessing originating versions of the information;
a module to verify the new information against information at location addresses resolved by the UPUNI, if verification is desired;
a module to add an entry of the new information's availability into a local data-structure to catalog information items available on a peer for transmission to others, wherein the entry into the local data-structure is keyed by UPUNI;
a module to provide data from the local catalog data-structure to a peer to aggregate catalog data into a centralized data-structure.

115. A program stored on a medium readable by a processor, the program, comprising:
a module to mine source identifying data as metadata from within new information and querying a database holding unique, persistent, and universal name identifier (UPUNI) and metadata (MUPUNI database) with the mined metadata for an UPUNI corresponding to the mined metadata, if the new information has no embedded UPUNI;
a module to resolve a new information's UPUNI to location addresses for accessing originating versions of the information;
a module to add an entry of the new information's availability into a local data-structure to catalog information items available on a peer for transmission to others.

116. The medium of claim 115, wherein the local data-structure is in an UPUNI resolution system.

117. The medium of claim 115, further comprising:
a module to determine if there is new information to catalog.

118. The medium of claim 115, further comprising:
a module to determine if the new information contains an embedded unique, persistent, and universal name identifier (UPUNI).

119. The medium of claim 115, further comprising:
a module to embed an UPUNI corresponding to the new information within the new information, if the new information has no embedded UPUNI.

120. The medium of claim 119, wherein the corresponding UPUNI is obtained in response to the metadata query to the MUPUNI database.

121. The medium of claim 115, wherein the resolution is a request to a digital rights clearinghouse to enable access of the information.

122. The medium of claim 121, wherein the request is achieved by way of an enhanced DOI grammar request.

123. The medium of claim 115, further comprising:
a module to verify the new information against information at location addresses resolved by the UPUNI.

124. The medium of claim 123, wherein the verification is achieved by way of an enhanced DOI grammar request.

125. The medium of claim 115, wherein the entry into the local data-structure includes location addresses of peers making the information available.

126. The medium of claim 115, wherein the entry into the local data-structure is keyed by UPUNI.

127. The medium of claim 115, wherein the entry into the local data-structure is of the UPUNI, if the new information is verified the information at a location referenced by the UPUNI.

128. The medium of claim 115, wherein the entry into the local data-structure occurs only if the new information is verified against information at location addresses resolved by the UPUNI.

129. The medium of claim 115, further comprising:
a module to provide data from the local catalog data-structure to a peer to aggregate catalog data into a centralized data-structure.

130. The medium of claim 129, wherein the aggregating peer catalogs provided information items including a reference to peers that provide the data from their local catalog.

131. The medium of claim 129, wherein the centralized data-structure may be queried for local peers.

132. The medium of claim 129, wherein the centralized data-structure may be queried for information items.

133. The medium of claim 129, wherein the aggregating peer may provide query results of local peers holding requested information items.

134. The medium of claim 129, wherein the aggregating peer may provide query results of information items available at the local peers.

135. The medium of claim 129, wherein there may be multiple aggregating peers aggregating catalog data.

136. The medium of claim 129, wherein there may be multiple centralized data-structures for aggregating catalog data.

137. The medium of claim 129, wherein the centralized data-structure is in an UPUNI resolution system.

138. A program stored on a medium readable by a processor, the program, comprising:
a module to obtain a request for desired information;
a module to query a database holding unique, persistent, and universal name identifiers (UPUNI) and metadata (MUPUNI database) for desired information, if an associated UPUNI is unknown for the desired information, wherein the MUPUNI query is based on metadata query tokens;
a module to obtain an UPUNI for the desired information, wherein the UPUNI is obtained from query results from the MUPUNI database, if an associated UPUNI is unknown for the desired information;
a module to search for peers with the desired information that corresponds to the obtained UPUNI;
a module to obtain search results;
a module to identify candidate peers from which to obtain desired information that corresponds to the obtained UPUNI;
a module to request desired information from at least one candidate peer;
a module to obtain the desired information from at least one candidate peer;
a module to verify the obtained information against information at a location address resolved by the obtained UPUNI.

139. A program stored on a medium readable by a processor, the program, comprising:
a module to search for peers with an obtained unique, persistent, and universal name identifiers (UPUNI) for desired information, which corresponds to the obtained UPUNI;
a module to obtain search results;
a module to identify candidate peers from which to obtain desired information that corresponds to the obtained UPUNI;
a module to request desired information from a candidate peer;
obtaining the desired information from the candidate peer.

140. The medium of claim 139, further comprising:
obtaining a request for desired information.

141. The medium of claim 140, wherein the request for desired information is made with an UPUNI associated with the desired information.

142. The medium of claim 140, wherein the request for desired information is made with metadata query tokens regarding the desired information, the metadata query tokens being sent to the MUPUNI and resolved into an UPUNI.

143. The medium of claim 139, further comprising:
a module to query an (UPUNI) and metadata database (MUPUNI database) for desired information, if an associated UPUNI is unknown for the desired information.

144. The medium of claim 143, wherein the MUPUNI query is based on metadata query tokens.

145. The medium of claim 143, wherein the UPUNI is obtained from query results from the MUPUNI database.

146. The medium of claim 139, further comprising:
a module to obtain an UPUNI for desired information, if an associated UPUNI is unknown for the desired information.

147. The medium of claim 146, wherein the UPUNI is obtained from a reference.

148. The medium of claim 147, wherein the reference is a hyperlink.

149. The medium of claim 83, wherein the searched for peers is conducted on an UPUNI resolution system.

150. The medium of claim 139, wherein the searched for peers is conducted on other peers.

151. The medium of claim 139, wherein the searched for peers is conducted on peer-to-peer list collector.

152. The medium of claim 139, wherein the searched for peers host the desired information.

153. The medium of claim 139, wherein the searched for peers reference the desired information.

154. The medium of claim 139, wherein the peer request for desired information is made to a plurality of candidate peers.

155. The medium of claim 139, wherein the desired results are obtained from a plurality of candidate peers.

156. The medium of claim 139, further comprising:
a module to verify the obtained information against information at a location address resolved by the obtained UPUNI.

157. The medium of claim 156, wherein the verification is achieved by way of an enhanced DOI grammar request.

158. A program stored on a medium readable by a processor, the program, comprising:
a module to identify information to be validated;
a module to obtain an unique, persistent, and universal name identifier (UPUNI) for the identified information;
a module to request validating credentials for the identified information from an UPUNI resolution system with the obtained UPUNI;
a module to obtain the requested validating credentials;
a module to compare a representative digital verification value against the obtained validating credentials,
wherein the representative digital verification values may include checksums, comparisons of information, comparisons of information tags, digital certificates, digital fingerprints, encryption keys, the identified information itself, and passwords, and
wherein the identified information is validated if the comparison against obtained validating credentials results in matching values.

159. A program stored on a medium readable by a processor, the program, comprising:
a module to obtain an unique, persistent, and universal name identifier (UPUNI) for identified information;
a module to request validating credentials for the identified information from an UPUNI resolution system with the obtained UPUNI;
a module to obtain the requested validating credentials;
a module to compare a representative digital verification value against the obtained validating credentials.

160. The medium of claim 159, wherein the UPUNI is embedded within the information.

161. The medium of claim 159, wherein the UPUNI is resolved from an UPUNI and metadata database.

162. The medium of claim 159, wherein the UPUNI is provided by a user.

163. The medium of claim 159, wherein the validating credentials request is achieved by way of an enhanced DOI grammar request.

164. The medium of claim 159, wherein validating credentials may include: checksums, digital certificates, digital fingerprints, encryption keys, information itself, passwords, values resulting from comparisons of information, and values resulting from comparisons of information tags.

165. The medium of claim 159, further comprising:
computing a representative digital verification value from the identified information.

166. The medium of claim 165, wherein the representative digital verification value computation may include: comparisons of information, comparisons of information tags, generation of checksums, generation of digital certificates, generation of digital fingerprints, generation of encryption keys, provision of passwords, and selecting portions of the identified information itself.

167. The medium of claim 166, wherein the selected portions may include the entirety of the identified information itself.

168. The medium of claim 159, wherein the representative digital verification values may include: checksums, digital certificates, digital fingerprints, encryption keys, the identified information itself, passwords, values resulting from comparisons of information, and values resulting from comparisons of information tags.

169. The medium of claim 159, wherein the identified information is validated if the comparison against obtained validating credentials results in matching values.

170. An apparatus, comprising:
a processor;
a memory, communicatively connected to the processor;
a program, stored in the memory, including,
a module to determine if there is new information to catalog;
a module to embed an unique, persistent, and universal name identifier (UPUNI) corresponding to the new information within the new information, if the new information has no embedded UPUNI;
a module to mine source identifying data as metadata from within new information and querying a database holding UPUNI and metadata (MUPUNI database) with the mined metadata for an UPUNI corresponding to the mined metadata, if the new information has no embedded UPUNI, wherein the UPUNI is obtained in response to the metadata query to the MUPUNI database;
a module to resolve a new information's UPUNI to location addresses for accessing originating versions of the information;
a module to verify the new information against information at location addresses resolved by the UPUNI, if verification is desired;
a module to add an entry of the new information's availability into a local data-structure to catalog information items available on a peer for transmission to others, wherein the entry into the local data-structure is keyed by UPUNI;
a module to provide data from the local catalog data-structure to a peer to aggregate catalog data into a centralized data-structure.

171. An apparatus, comprising:
a processor;
a memory, communicatively connected to the processor;
a program, stored in the memory, including, a module:
a module to mine source identifying data as metadata from within new information and querying a database holding unique, persistent, and universal name identifier (UPUNI) and metadata (MUPUNI database) with the mined metadata for an UPUNI corresponding to the mined metadata, if the new information has no embedded UPUNI;
a module to resolve a new information's UPUNI to location addresses for accessing originating versions of the information;
a module to add an entry of the new information's availability into a local data-structure to catalog information items available on a peer for transmission to others.

172. The apparatus of claim 171, wherein the local data-structure is in an UPUNI resolution system.

173. The apparatus of claim 171, further comprising:
a module to determine if there is new information to catalog.

174. The apparatus of claim 171, further comprising:
a module to determine if the new information contains an embedded unique, persistent; and universal name identifier (UPUNI).

175. The apparatus of claim 17 1, further comprising:
a module to embed an UPUNI corresponding to the new information within the new information, if the new information has no embedded UPUNI.

176. The apparatus of claim 175, wherein the corresponding UPUNI is obtained in response to the metadata query to the MUPUNI database.

177. The apparatus of claim 171, wherein the resolution is a request to a digital rights clearinghouse to enable access of the information.

178. The apparatus of claim 177, wherein the request is achieved by way of an enhanced DOI grammar request.

179. The apparatus of claim 171, further comprising:
a module to verify the new information against information at location addresses resolved by the UPUNI.

180. The apparatus of claim 179, wherein the verification is achieved by way of an enhanced DOI grammar request.

181. The apparatus of claim 171, wherein the entry into the local data-structure includes location addresses of peers making the information available.

182. The apparatus of claim 171, wherein the entry into the local data-structure is keyed by UPUNI.

183. The apparatus of claim 171, wherein the entry into the local data-structure is of the UPUNI, if the new information is verified the information at a location referenced by the UPUNI.

184. The apparatus of claim 171, wherein the entry into the local data-structure occurs only if the new information is verified against information at location addresses resolved by the UPUNI.

185. The apparatus of claim 171, further comprising:
a module to provide data from the local catalog data-structure to a peer to aggregate catalog data into a centralized data-structure.

186. The apparatus of claim 185, wherein the aggregating peer catalogs provided information items including a reference to peers that provide the data from their local catalog.

187. The apparatus of claim 185, wherein the centralized data-structure may be queried for local peers.

188. The apparatus of claim 185, wherein the centralized data-structure may be queried for information items.

189. The apparatus of claim 185, wherein the aggregating peer may provide query results of local peers holding requested information items.

190. The apparatus of claim 185, wherein the aggregating peer may provide query results of information items available at the local peers.

191. The apparatus of claim 185, wherein there may be multiple aggregating peers aggregating catalog data.

192. The apparatus of claim 185, wherein there may be multiple centralized data-structures for aggregating catalog data.

193. The apparatus of claim 185, wherein the centralized data-structure is in an UPUNI resolution system.

194. An apparatus, comprising:
a processor;
a memory, communicatively connected to the processor;
a program, stored in the memory, including, a module:
a module to obtain a request for desired information;
a module to query a database holding unique, persistent, and universal name identifiers (UPUNI) and metadata (MUPUNI database) for desired information, if an associated UPUNI is unknown for the desired information, wherein the MUPUNI query is based on metadata query tokens;
a module to obtain an UPUNI for the desired information, wherein the UPUNI is obtained from query results from the MUPUNI database, if an associated UPUNI is unknown for the desired information;
a module to search for peers with the desired information that corresponds to the obtained UPUNI;
a module to obtain search results;
a module to identify candidate peers from which to obtain desired information that corresponds to the obtained UPUNI;
a module to request desired information from at least one candidate peer;
a module to obtain the desired information from at least one candidate peer;
a module to verify the obtained information against information at a location address resolved by the obtained UPUNI.

195. An apparatus, comprising:
a processor;
a memory, communicatively connected to the processor;
a program, stored in the memory, including, a module:
a module to search for peers with an obtained unique, persistent, and universal name identifiers (UPUNI) for desired information, which corresponds to the obtained UPUNI;
a module to obtain search results;
a module to identify candidate peers from which to obtain desired information that corresponds to the obtained UPUNI;
a module to request desired information from a candidate peer;
obtaining the desired information from the candidate peer.

196. The apparatus of claim 195, further comprising:
obtaining a request for desired information.

197. The apparatus of claim 196, wherein the request for desired information is made with an UPUNI associated with the desired information.

198. The apparatus of claim 196, wherein the request for desired information is made with metadata query tokens regarding the desired information, the metadata query tokens being sent to the MUPUNI and resolved into an UPUNI.

199. The apparatus of claim 195, further comprising:
a module to query an (UPUNI) and metadata database (MUPUNI database) for desired information, if an associated UPUNI is unknown for the desired information.

200. The apparatus of claim 199, wherein the MUPUNI query is based on metadata query tokens.

201. The apparatus of claim 199, wherein the UPUNI is obtained from query results from the MUPUNI database.

202. The apparatus of claim 195, further comprising:
a module to obtain an UPUNI for desired information, if an associated UPUNI is unknown for the desired information.

203. The apparatus of claim 202, wherein the UPUNI is obtained from a reference.

204. The apparatus of claim 203, wherein the reference is a hyperlink.

205. The apparatus of claim 195, wherein the searched for peers is conducted on an UPUNI resolution system.

206. The apparatus of claim 195, wherein the searched for peers is conducted on other peers.

207. The apparatus of claim 195, wherein the searched for peers is conducted on peer-to-peer list collector.

208. The apparatus of claim 195, wherein the searched for peers host the desired information.

209. The apparatus of claim 195, wherein the searched for peers reference the desired information.

210. The apparatus of claim 195, wherein the peer request for desired information is made to a plurality of candidate peers.

211. The apparatus of claim 195, wherein the desired results are obtained from a plurality of candidate peers.

212. The apparatus of claim 195, further comprising:
a module to verify the obtained information against information at a location address resolved by the obtained UPUNI.

213. The apparatus of claim 212, wherein the verification is achieved by way of an enhanced DOI grammar request.

214. An apparatus, comprising:
a processor;
a memory, communicatively connected to the processor;
a program, stored in the memory, including, a module:
a module to identify information to be validated;
a module to obtain an unique, persistent, and universal name identifier (UPUNI) for the identified information;
a module to request validating credentials for the identified information from an UPUNI resolution system with the obtained UPUNI;
a module to obtain the requested validating credentials;
a module to compare a representative digital verification value against the obtained validating credentials,
wherein the representative digital verification values may include checksums, comparisons of information, comparisons of information tags, digital certificates, digital fingerprints, encryption keys, the identified information itself, and passwords, and
wherein the identified information is validated if the comparison against obtained validating credentials results in matching values.

215. An apparatus, comprising:
a processor;
a memory, communicatively connected to the processor;
a program, stored in the memory, including, a module:
a module to obtain an unique, persistent, and universal name identifier (UPUNI) for identified information;
a module to request validating credentials for the identified information from an UPUNI resolution system with the obtained UPUNI;
a module to obtain the requested validating credentials;
a module to compare a representative digital verification value against the obtained validating credentials.

216. The apparatus of claim 215, wherein the UPUNI is embedded within the information.

217. The apparatus of claim 215, wherein the UPUNI is resolved from an UPUNI and metadata database.

218. The apparatus of claim 215, wherein the UPUNI is provided by a user.

219. The apparatus of claim 215, wherein the validating credentials request is achieved by way of an enhanced DOI grammar request.

220. The apparatus of claim 215, wherein validating credentials may include: checksums, digital certificates, digital fingerprints, encryption keys, information itself, passwords, values resulting from comparisons of information, and values resulting from comparisons of information tags.

221. The apparatus of claim 215, further comprising:
computing a representative digital verification value from the identified information.

222. The apparatus of claim 221, wherein the representative digital verification value computation may include: comparisons of information, comparisons of information tags, generation of checksums, generation of digital certificates, generation of digital fingerprints, generation of encryption keys, provision of passwords, and selecting portions of the identified information itself.

223. The apparatus of claim 222, wherein the selected portions may include the entirety of the identified information itself.

224. The apparatus of claim 215, wherein the representative digital verification values may include: checksums, digital certificates, digital fingerprints, encryption keys, the identified information itself, passwords, values resulting from comparisons of information, and values resulting from comparisons of information tags.

225. The apparatus of claim 215, wherein the identified information is validated if the comparison against obtained validating credentials results in matching values.
